(19) United States
(12) Patent Application Publication
(10) Pub. No.: US 2022/0270062 A1
(43) Pub. Date: Aug. 25, 2022

(54) Methods and systems for revealing information in content selectively

(71) Applicant: Hiroshi Sasaki, Chorley (GB)

(72) Inventor: Hiroshi Sasaki, Chorley (GB)

(21) Appl. No.: 17/556,021

(22) Filed: Dec. 20, 2021

Related U.S. Application Data
(60) Provisional application No. 63/152,944, filed on Feb. 24, 2021.

(51) Int. Cl. G06Q 20/12; G06Q 20/38; G06Q 20/06; H04L 9/32

(52) U.S. Cl. CPC G06Q 20/1235; G06Q 20/389; G06Q 20/065; G06Q 20/38215; H04L 9/3213; H04L 2209/04; H04L 2209/16; H04L 2209/60; H04L 2209/56

(57) ABSTRACT

Methods and systems with “selective-information-revealing” features are described. The features enable a user of an online platform such as an online forum or online publishing platform to post content with one or more elements masked. With the features, an automatically generated suggestion of one or more elements of the content to mask is presented with the suggested elements visually differentiated from the other elements of the content. User interface elements are also provided enabling the user to modify the set of elements to be masked. Further described are additional earn-from-content features enabling a user to be rewarded by disclosing his masked content or selling the privilege of exclusive capabilities regarding his content to another user, and “share-revenue” features enabling revenue earned via earn-from-content features to be shared among a plurality of users.

### FIELD OF THE INVENTION

The present invention relates to computer-implemented methods and computer systems for use in online platforms such as online forums or online publishing platforms. More specifically, the present invention relates to methods and systems that provide, when a user posts a piece of user-generated content, automatic suggestions of one or more elements in the content to be masked and user interface elements enabling the user to modify or specify the one or more elements in the content to be masked.

### BACKGROUND

People share information on applications or services such as online forums, online publishing platforms, question & answer websites, blogs, news media, or social media. The usefulness of such applications or services is highly dependent upon the quality and volume of user-generated content thereon, while the incentive of users for sharing valuable information on such applications and services is limited when they have no means to be rewarded by their sharing.

A method to reward a user for his sharing of information on an application or service is to present his information only partially to viewers and ask them to pay a price for seeing the rest of the information. This same method is often used by online news media or online publishing platforms to sell content. On such online news media or online publishing platforms, predetermined part(s) of a piece of content (e.g., the first few pages or paragraphs of the piece of content) are presented to a viewer for the purpose of attracting him to consider purchasing the rest of the piece of content (that is hidden until he pays to see it). However, in cases where some parts of a piece of information are particularly more important than other parts, such a way of partial disclosure is not effective in motivating a user to pay because if the disclosed parts include the particularly important parts it would spoil his motivation for paying for the rest of the information. Examples of such information are ideas or knowledge. When information is an idea or knowledge, the parts of it which convey unique, rare, inspirational, or novel matters are particularly valuable to viewers. Hence, the ideal way to motivate a user to pay for a piece of information is to disclose only the parts that include enough information for him to determine whether the whole of the piece of information is likely to include the particularly important parts that he considers worth paying for whilst not revealing them.

The above “reward-on-disclosure” method is an effective way to reward a user for his sharing of information if the partial disclosure is executed with the above considerations being attended to. However, in some scenarios, because of a user's economic needs, the user might want to receive his desired amount of reward within a shorter amount of time than is the case with the reward-on-disclosure method. In such scenarios, the user might not see a benefit of using a system or service which supplies the reward-on-disclosure method as its only earning method. In another scenario, a piece of information is only valuable when it is disclosed to one person or a limited number of people. For example, if the technical know-how in a piece of content can bring an advantageous competitiveness to a company when it is known to only the company, the reward-on-disclosure method is not suitable as it is a method to disclose content to an unspecified number of users. Also, in a further scenario, the reward-on-disclosure method may not enable a content creator or owner to benefit from his or her content in accordance with its merits to viewers. This scenario happens because, in the free market, the price of information is not necessarily decided by how beneficial it is but often by how rare it is. For example, educational content which explains well publicly available knowledge is beneficial but may not bring reward accordingly because of its lack of uniqueness, rarity, inspiration, or novelty. However, to make applications or services (e.g., online forums, online publishing platforms) useful to users, it is important to motivate users to post such kind of “beneficial but poorly-rewarded” content. Under these circumstances, for the success of those applications or services, it is ideal to supply wider options for earning opportunities to users in addition to the reward-on-disclosure method.

### BRIEF DESCRIPTION OF DRAWINGS

Some embodiments are illustrated by way of example, and not limitation, in the figures of the accompanying drawings.

FIG. 1 is a block diagram illustrating various components or functional modules of an online forum, consistent with embodiments of the invention.

FIG. 2 is a flow diagram representing a method for enabling a user of an online forum to post a reply to a question allowing him to hide elements of the reply content and to specify the rewards he wants to receive from another user in exchange for disclosing the whole reply content, consistent with embodiments of the invention.

FIG. 3 illustrates structures of a mask element table where elements that are to be masked in user-generated content are stored, consistent with embodiments of the invention.

FIG. 4 illustrates a structure of a reward request table where rewards requested in exchange for disclosing the whole information in a piece of content are stored, and a structure of a reward record table where records of the fulfillment of each requested reward are stored, consistent with embodiments of the invention.

FIG. 5 is a flow diagram representing a method for enabling a user of an online forum to view a whole piece of reply content by fulfilling rewards requested by the replier, consistent with embodiments of the invention.

FIG. 6 is a flow diagram representing a method for determining whether a piece of content is to be disclosed without its elements being masked to an information seeker on an online forum, consistent with embodiments of the invention.

FIG. 7 is a flow diagram representing a method for automatically determining candidate elements to be masked in a piece of content in an online forum, consistent with embodiments of the invention.

FIG. 8-1 is a flow diagram representing a detailed process of method operation 702 in FIG. 7 where an online forum divides original (unmasked) text content into text elements, consistent with embodiments of the invention.

FIG. 8-2 illustrates a sequence of text elements generated at method operation 816 in FIG. 8-1 where each text element is accompanied by its features, consistent with embodiments of the invention.

FIG. 9 is a flow diagram representing a detailed process of method operation 704 in FIG. 7 where an online forum generates a masking score of each text element, consistent with embodiments of the invention.

FIG. 10 illustrates the rules that are used for generating a masking score for each text element, consistent with embodiments of the invention.

FIG. 11 is a flow diagram representing a detailed process of method operation 702 and 704 in FIG. 7 in the case where the type of the reply content is audio, video, or image, consistent with embodiments of the invention.

FIGS. 12 through 26 illustrate various user interfaces, and portions of user interfaces, for use in methods and systems for enabling a user of an online forum to post a reply to a question allowing him to hide the elements of the reply content and to specify the rewards he wants to receive from another user in exchange for disclosing the whole reply content, consistent with embodiments of the invention.

FIG. 27 illustrates various user interfaces, and portions of user interfaces, for use in methods and systems for enabling a user of an online forum to view a whole reply content by fulfilling rewards requested by the replier, consistent with embodiments of the invention.

FIG. 28 illustrates various user interfaces, and portions of user interfaces, for use in methods and systems for enabling a user of an online forum to vote for and to post a comment to the reply content, after the whole information of the reply content is disclosed, consistent with embodiments of the invention.

FIG. 29 is a block diagram illustrating various components or functional modules of an online publishing platform, consistent with embodiments of the invention.

FIG. 30 illustrates various user interfaces, and portions of user interfaces, on an online publishing platform and illustrates a piece of content referring to another piece of content with a hyperlink, consistent with embodiments of the invention.

FIG. 31 illustrates structures of a user-generated content table in an online forum where pieces of user-generated content are stored, consistent with embodiments of the invention.

FIG. 32 illustrates structures of a user-generated content table in an online publishing platform where pieces of user-generated content are stored, consistent with embodiments of the invention.

FIG. 33 illustrates structures of a link-content table in an online publishing platform where pieces of link-content are stored, consistent with embodiments of the invention.

FIG. 34 is a flow diagram representing a method for enabling the owner of a piece of content to sell his privilege of the exclusive capabilities regarding a piece of content to another user on an online forum or an online publishing platform, consistent with embodiments of the invention.

FIG. 35 illustrates structures of an owner-offer-record table in an online forum or an online publishing platform where the record is stored of an owner's offer to sell the privilege of the exclusive capabilities regarding a piece of content, consistent with embodiments of the invention.

FIG. 36 illustrates structures of an auction record table in an online forum or an online publishing platform where the record is stored of an auction for the privilege of the exclusive capabilities regarding a piece of content, consistent with embodiments of the invention.

FIG. 37 illustrates structures of a purchase-record-table in an online forum or an online publishing platform where the purchasing record is stored of the privilege of the exclusive capabilities regarding a piece of content, consistent with embodiments of the invention.

FIG. 38 is a piece of pseudocode of an example algorithm for enabling a plurality of users on an online forum to share the revenue in the event of a content owner receiving revenue from his content, consistent with embodiments of the invention.

FIG. 39 is a piece of pseudocode of an example algorithm for enabling a plurality of users on an online publishing platform to share the revenue in the event of a content owner receiving revenue from his content, consistent with embodiments of the invention.

FIG. 40 is a block diagram illustrating components of a machine, according to some example embodiments.

### DETAILED DESCRIPTION

Example methods and systems for facilitating the sharing of information (e.g., ideas, and knowledge) by solving conflicts of interests between information seekers and information holders are described. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

As information can play an important role in achieving economic gain, information has been often shared in exchange for various types of rewards. For example, hard copy publications such as books and magazines have been sold in bookstores.

When an information holder seeks to share his information to receive a reward, it is in his interest that the information is kept from being disclosed before receiving the reward, whilst an information seeker's interest is to determine whether the information includes the ideas or knowledge that he or she is seeking before paying the requested reward. The sale of publications in bookstores has worked to meet both parties' interests to some extent because information seekers have the opportunity to see part of the publications before purchasing without, however, being able to spend a long time seeing the contents without paying because bookstore keepers can restrict the information seeker from doing so, thus resulting in information holders' interests being protected.

Since people have started using the internet widely, free information has become more widely available creating a problem for the companies that make revenue by publishing information because the abundance of free information makes people reluctant to pay for information unless they think the information is worth paying for. Some means to solve this problem are already in use such as the partial sharing of the contents of digital books or online news media articles enabling information seekers to determine whether the whole information is worth the price being asked.

However, when the content of digital publications is about ideas or knowledge, the existing means for partial information disclosure have problems because the disclosure is carried out without considering how to hide the key concepts that lead the information seeker to the understanding of the ideas or the knowledge he or she is seeking. Consequently, for example, when an information seeker who is looking for a certain technological idea sees the partial contents of a digital book, he might find the idea he was looking for thus satisfying his purpose before purchasing the digital book. Conversely, the partial contents might not give enough information on whether the specific idea he is seeking is in the other part of the digital book resulting in him either not buying the digital book or buying the digital book only to find it is not useful for him.

Hence, when information holders disclose partial information regarding their ideas or knowledge, the key concepts that would lead the information seeker to the understanding of the ideas or knowledge need to be hidden in the partial information whilst there needs to be enough information for the information seeker to determine whether the whole information is likely to include the key concepts he is seeking.

Various aspects of the inventive methods and systems described herein aim to supply the means to reveal partial information which includes enough information for information seekers to determine the usefulness of the whole content whilst hiding key concepts of ideas or knowledge.

For example, consistent with some embodiments of the invention, on an online forum, when a user posts a reply to a question posted by a questioner, the online forum presents recommendations to the replier, on a device display, for which elements to hide in the reply.

In addition, the forum allows the replier to choose which elements to hide in the reply via a user interface element with which the parts of the contents of the reply which are to be hidden can be selected by giving inputs from input devices such as a computer mouse, touch panel, or touchpad.

Furthermore, the forum allows the replier to specify the rewards he requires in exchange for disclosing the whole reply via a user interface element such as a text input box in which the replier can specify rewards, or via a select menu from which he can select rewards from a list of rewards provided by the forum.

When another user visits the question page associated with the question, the online forum presents, on a device display, the reply with the elements that were chosen to be hidden not displayed. In the event that he wishes to see the whole content, the forum accepts the reward such as money (via a third-party payment service for example) and the forum presents the whole reply to the payer on receipt of all requested rewards.

Other aspects of the inventive subject matter are set forth below in connection with the description of the various figures.

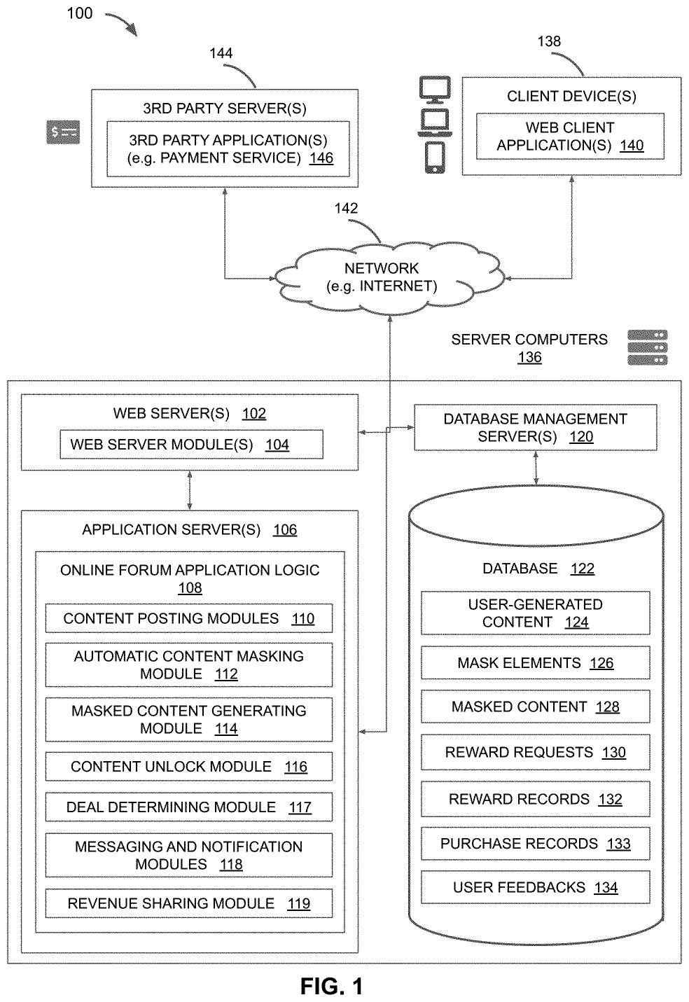

FIG. 1 is a block diagram illustrating various components or functional modules of an online forum 100, consistent with some examples. As illustrated in FIG. 1, in some embodiments, an online forum is implemented as a web-based application having web server module(s) 104 residing at one or more web servers 102, having online forum application logic 108 residing at one or more application servers 106, and having one or more database management servers 120 that facilitate access to one or more databases 122.

The database management server(s) 120 facilitates the writing and reading of data stored in tables of a database 122. In some alternative embodiments, other data structures may be utilized in addition to, or in place of, database tables.

In some embodiments, some of the various functional components of an online forum, including some of the various software modules, may be distributed across several server computers 136, providing application reliability and scalability. For instance, web server(s) 102, application server(s) 106, and database management server(s) 120 might reside on separate server computers. However, in other embodiments, some or all of these servers might reside and execute at the same server computers. Web server modules 104 receive requests from web client applications 140 such as web browsers residing and executing at various client computing devices 138 (e.g., desktop computer, laptop computer, smartphone, tablet computer) and communicate appropriate responses to the web client applications 140 via a network 142 (e.g., the Internet or Wide Area Network (WAN)). For example, the web server module(s) 104 may receive requests in the form of Hypertext Transport Protocol (HTTP) requests or other web-based application programming interface (API) requests. In addition, or as an alternative, the web server module 104 may utilize one or more web-based protocols to serve content to non-web browser clients, such as a web-based mobile application residing and executing on a mobile computing device, a set-top box, a television, or some other computing device.

The online forum application logic 108 is shown in FIG. 1 to include content posting modules 110, automatic content masking module 112, masked content generating module 114, content unlock module 116, deal determining module 117, messaging and notification modules 118, and revenue sharing module 119. The online forum application logic 108 may include all of these, whilst in other embodiments, it may include only some of these.

The database 122 is shown in FIG. 1 including, but not necessarily limited to, user-generated content 124, mask elements 126, masked content 128, reward requests 130, reward records 132, purchase records 133, and user feedbacks 134. In some embodiments, the database 122 may include all of these, whilst in other embodiments, it may include only some of these.

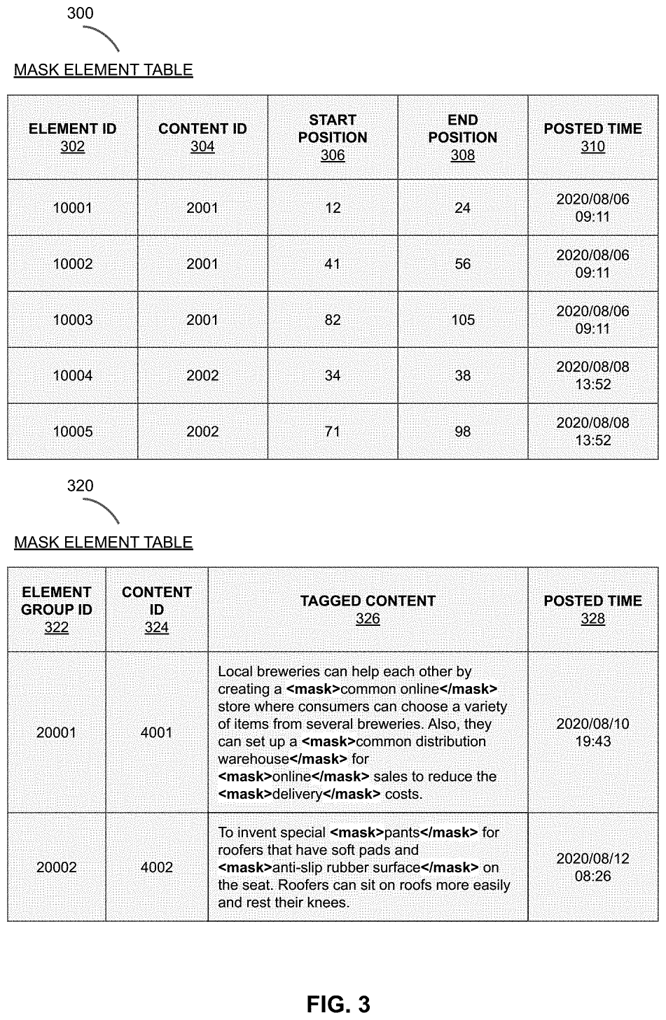

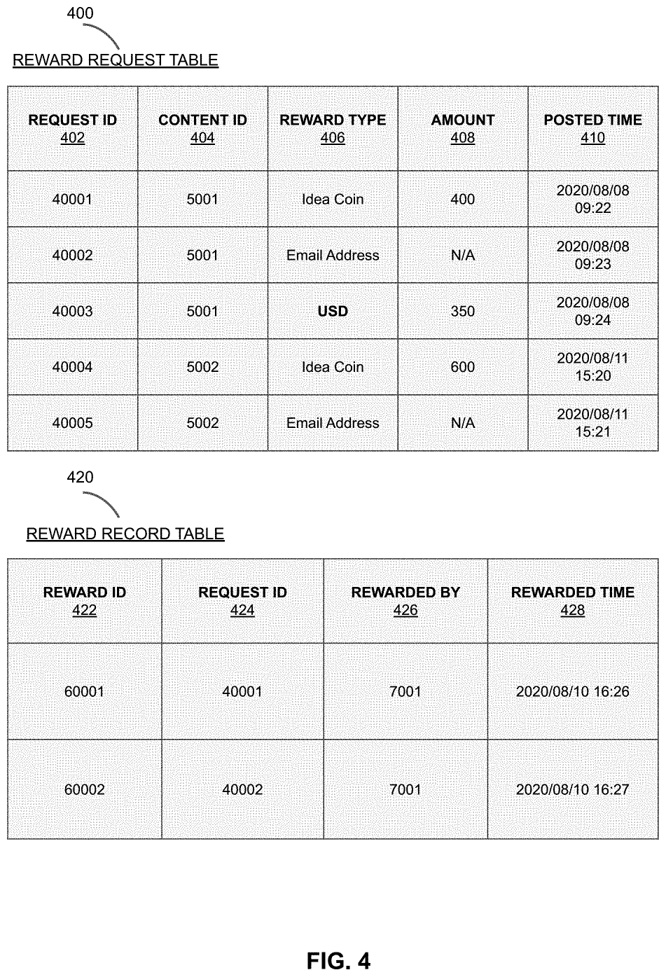

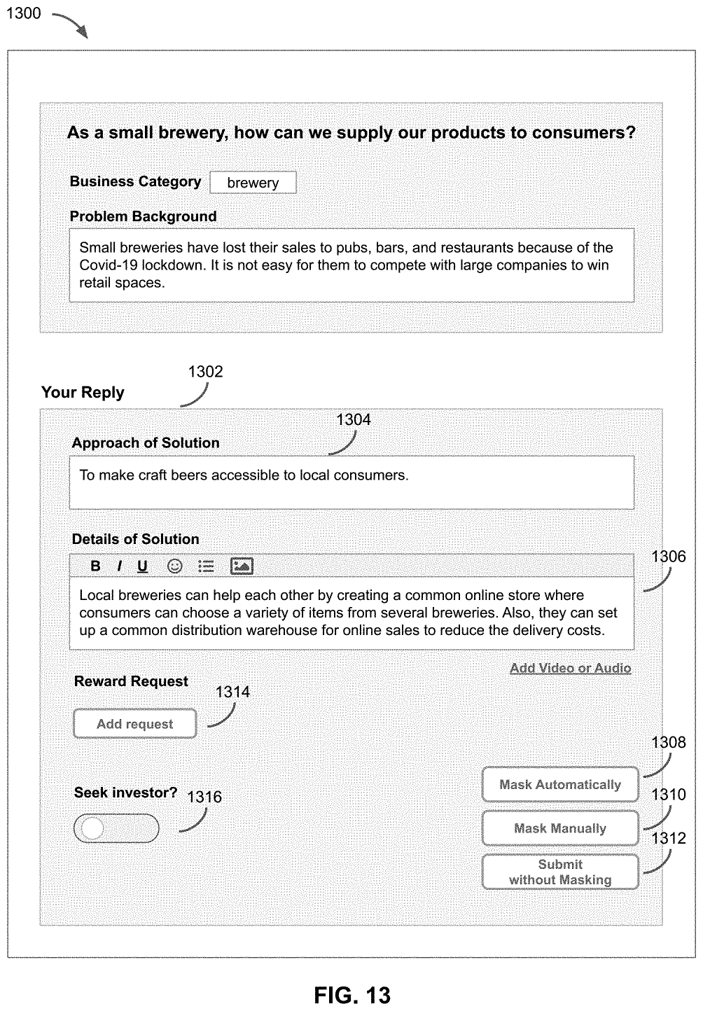

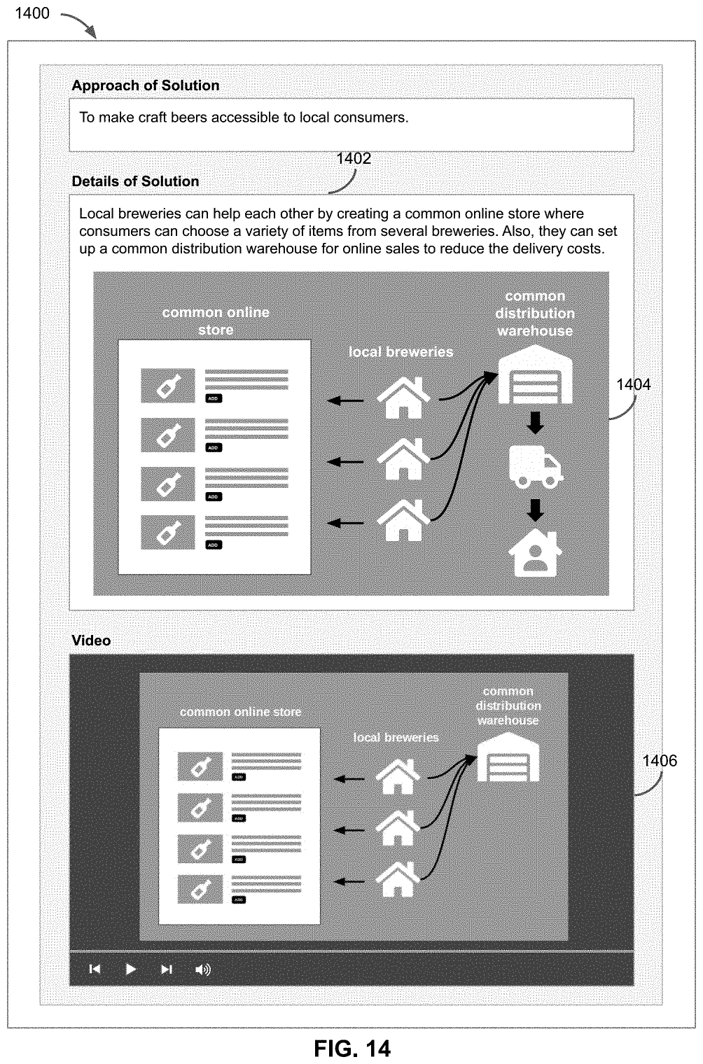

In general, the content posting modules 110 enable users to post user-generated content 124 such as questions, replies and comments, and other pieces of content. The types of the pieces of content may be, but are not limited to, text, diagram images, pictures, audio data, video data, or combinations of some of these. An example of a user-generated piece of content is shown in FIG. 13 and FIG. 14. In some embodiments, the content posting modules 110 also enable a user to specify mask elements 126 that are to be hidden in a piece of user-generated content and enable a user to specify reward requests 130 that are to be rewarded to the user in exchange for disclosing the whole contents of the user-generated content without its elements being masked. Examples of mask element tables are shown in FIG. 3. Also an example of a reward request table is shown at 400 in FIG. 4.

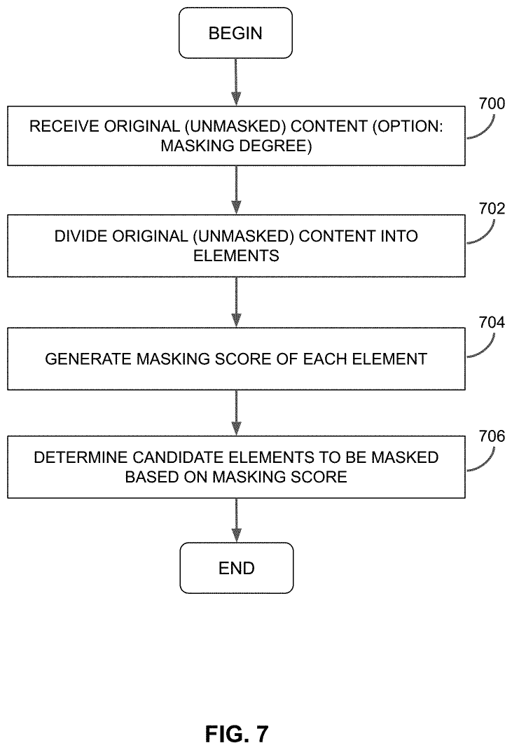

Returning now to FIG. 1, the automatic content masking module 112 determines candidate elements to be masked in a piece of user-generated content with the procedure described in FIG. 7.

The masked content generating module 114 generates masked content 128 with the elements that are to be hidden being masked by referring to the user-generated content 124 and the mask elements 126.

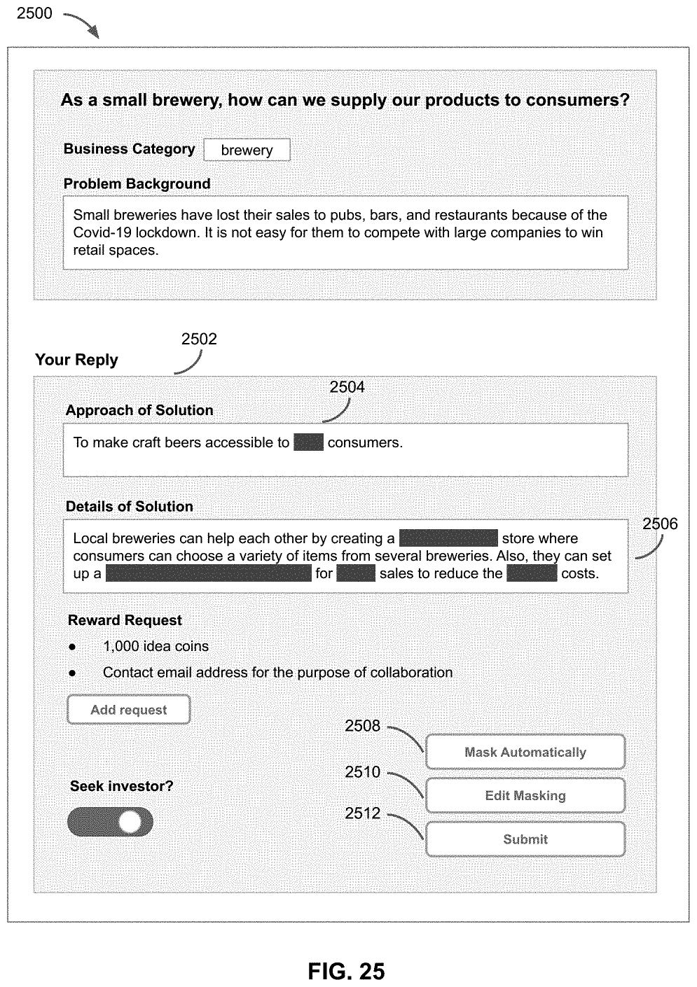

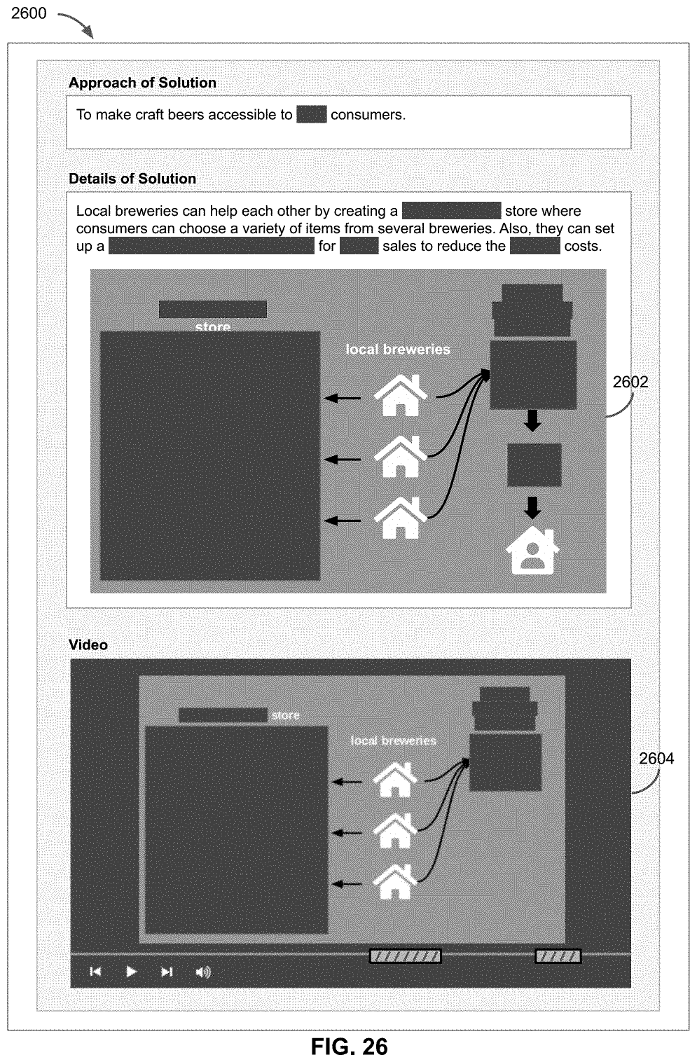

The data types of the masked content 128 might be, but are not limited to, text, image, audio, or video depending on the data types of the original content. However, the data type of masked content does not necessarily have to be the same as its original content. For example, masked content may be an image of text whilst its original content is text. Masked content may be stored in the database 122 as binary (or text) data or stored in separate storage(s) as files along with the database 122 storing the file paths for those files. Examples of masked content are shown in FIG. 25 and FIG. 26.

The content unlock module 116 enables a user to view the whole contents of another user's generated content when the first user has fulfilled all reward requests that are associated with the user-generated content, by referring to the reward records 132 where each record is created when a user fulfills a reward request that is associated with a particular piece of user-generated content. In some embodiments, after a user has viewed the whole contents of another user's generated content, an online forum might accept feedbacks from the first user such as a user rating (voting) and/or comment(s) and those feedbacks will be stored in user feedbacks 134.

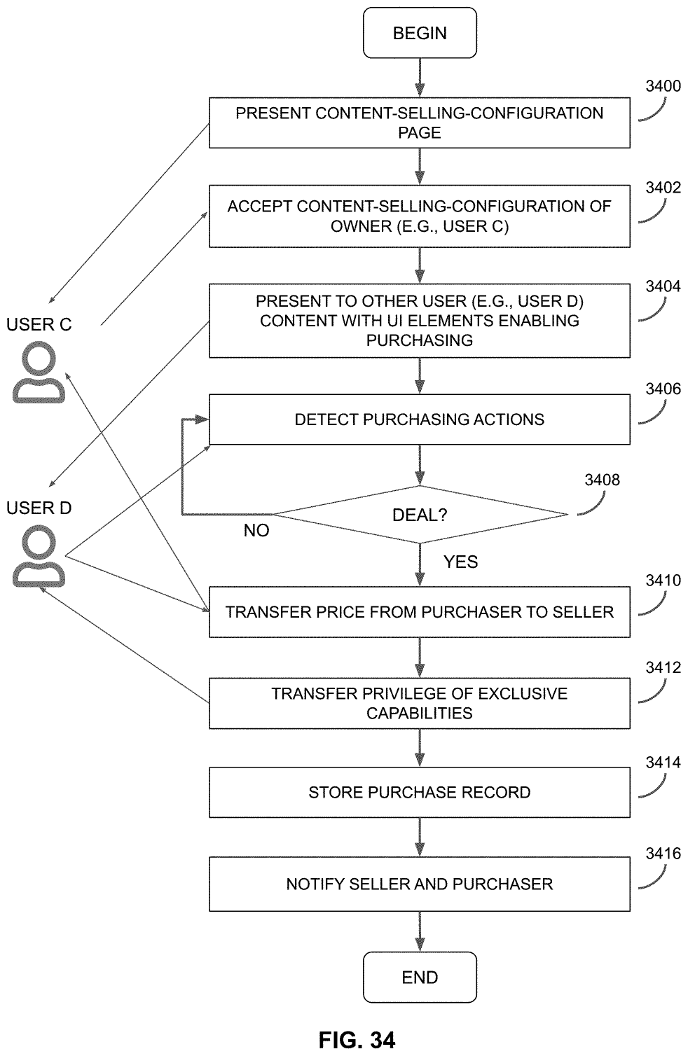

The deal determining module 117 determines whether a deal regarding a piece of content is established when the owner of a piece of content wishes to sell the privilege regarding it. The details of the owner's privilege regarding a piece of content and the process of selling it to another user will be described in conjunction with FIG. 34.

The messaging and notification modules 118 communicate messages or notifications to users for various purposes such as recommending content, encouraging the posting of content, and confirming the actions made by users.

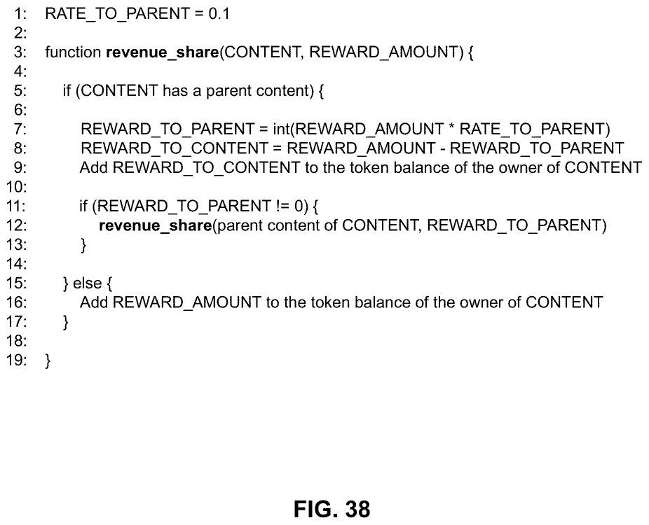

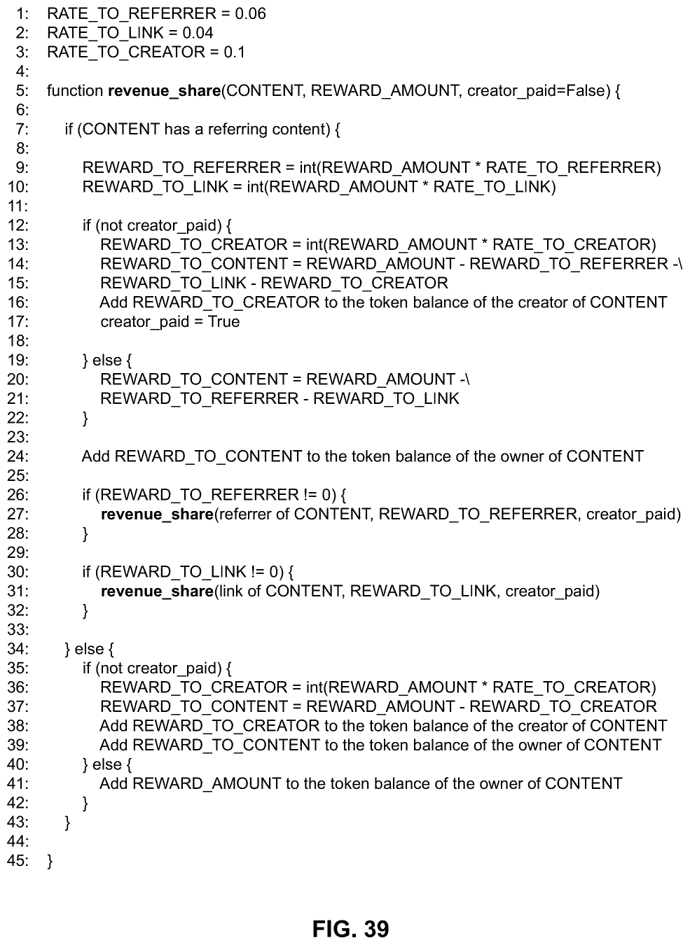

The revenue sharing module 119 shares revenue with other users in addition to the user who has been rewarded. The process of revenue-sharing will be described in conjunction with FIG. 38 and FIG. 39.

Of course, the online forum application logic 108 may include a number of other logical components to perform a variety of other tasks and functions beyond the immediate scope of the present inventive subject matter. Also, the database 122, may include a number of other data to perform a variety of other tasks and functions beyond the immediate scope of the present inventive subject matter. As such, to avoid obscuring the inventive subject matter in unnecessary detail, these various functional components and data have not been included in FIG. 1.

In some embodiments, an online forum might utilize third-party application(s) 146 such as payment service application(s), executed on third-party server machine(s) 144 via a network 142.

Also, in some embodiments, an online forum may be implemented as decentralized applications (Dapps) instead of a client-server model system. Dapps have backend code running on a decentralized peer-to-peer network to submit the request, retrieve data from the blockchains, and communicate with other applications (e.g., other Dapps), unlike a client-server model system that has backend code running on centralized servers and manages data with databases residing at centralized servers with client applications communicating with centralized servers.

The further explanation of the invention written below is based on embodiments that are implemented as client-server model systems to avoid obscuring the inventive subject matter. However, this invention is not limited to client-server model systems.

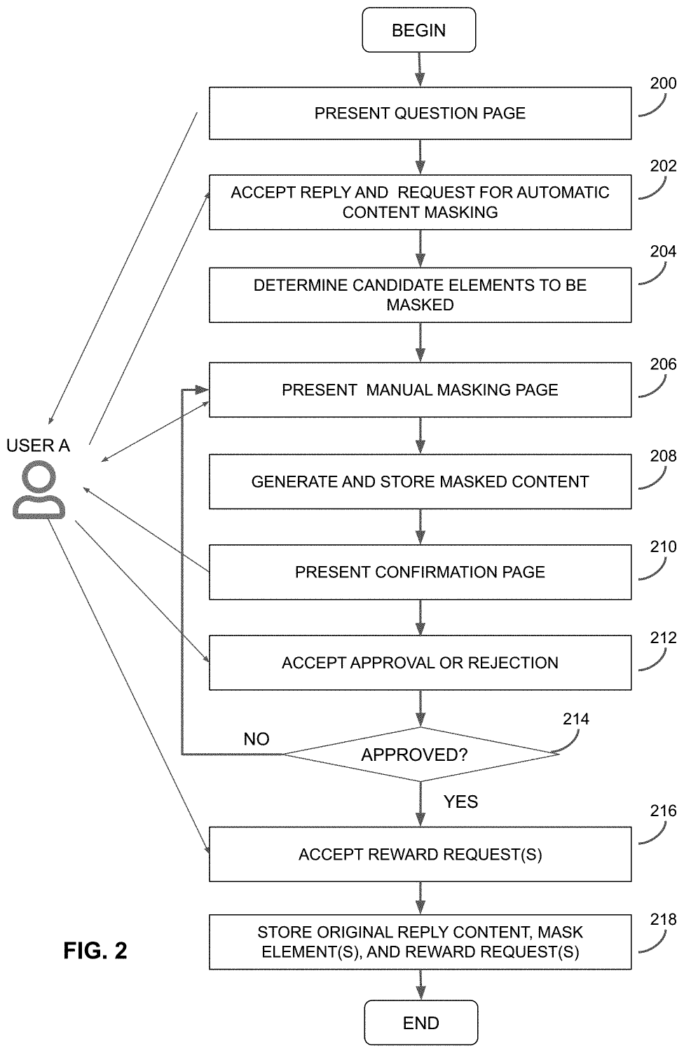

FIG. 2 is a flow diagram representing a method for enabling a user of an online forum to post a reply to a question and allowing him to hide the elements of the reply content and to specify the rewards he seeks to receive from another user in exchange for disclosing the whole reply content, consistent with embodiments of the invention.

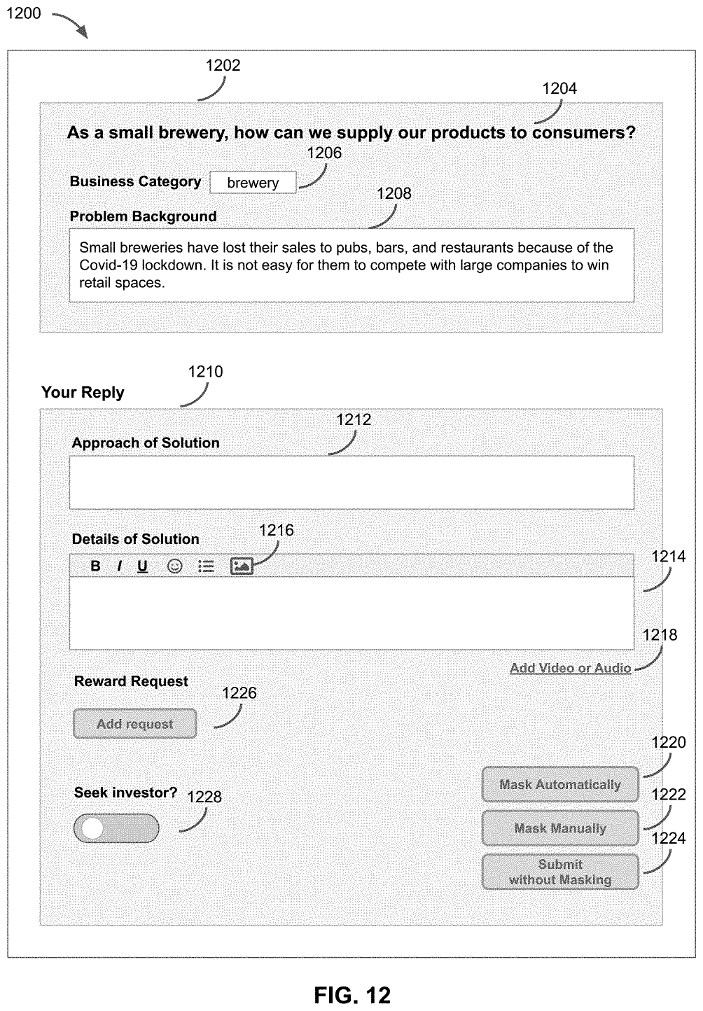

As illustrated in FIG. 2, the method begins at method operation 200 when an online forum presents to a user a question page for a question. For purposes of this example, the user to whom the question page is presented is shown in FIG. 2 as “USER A”. The question page displays a question that a user has posted, and in addition, the question page enables the user (e.g, USER A) to post a reply interacting with user interface elements such as text input boxes and buttons. An example of a question page consistent with an embodiment of the invention is illustrated in FIG. 12.

At method operation 202, the online forum accepts reply content and the request for automatic content masking from the user (e.g., USER A). After receiving the reply content and the request for automatic content masking, at method operation 204, the online forum determines candidates for elements to be masked in the reply content as will be described in more detail below in conjunction with FIG. 7.

When the candidate elements are determined, at method operation 206, the online forum presents a manual masking page that enables the user (e.g., USER A) to add elements to be hidden in the reply content in addition to the candidate elements that are suggested automatically at 204 by interacting with user interface elements in the manual masking page. The manual masking page also enables the user to dismiss or change the range(s) of one or more candidate elements that are suggested automatically. For the purpose of conciseness, an element that is selected to be hidden either automatically by the online forum or manually by a user is called “candidate mask element” before confirmation of the selection (that is described in connection with method operation 210) and “mask element” after confirmation.

The candidate mask elements are highlighted in the manual masking page according to the information that identifies the position (position identifier) of each candidate mask element generated at method operation 204 or generated manually by a user at method operation 206. Examples of position identifiers and highlighting methods are described below consistent with embodiments of the invention.

When the content is a text, a candidate mask element is a piece of the text (text element) and the position identifier is the starting position and the ending position of the text element. For example, if a text element is chosen as a candidate mask element and it starts at the 11-th letter and ends at the 15-th letter, the 5 letters' length of the text content is highlighted in client applications (e.g., web browser applications, mobile applications) by adding to the text element a markup tag (e.g., HTML tag) which differentiates its visual presentation. For example, in a web browser application, HTML tags can specify the visual presentation of the tagged element such as the color of the text or the color of the background using Cascading Style Sheets (CSS).

When the content is an audio or a video, a candidate mask element is a segment of the audio or video and the position identifier is the starting time and the ending time of the audio (or video) segment. For example, if an audio (or a video) segment is chosen as a candidate mask element and it starts at 10 seconds into the content and ends at 15 seconds, the 5 seconds duration part of the time progress bar is highlighted. This highlighting can be achieved by overlaying a semi-transparent rectangle object (e.g., HTML div element) on the progress bar for example.

When the content is an image (including diagram and video frame), a candidate mask element is an area of the image and the position identifier is the set of vertices of the image area (e.g., rectangle area). For example, if a rectangle shaped image area is chosen as a candidate mask element and if the image area has the top-left vertex at (x1, y1) and the bottom-right vertex at (x2, y2), the image area is highlighted by overlaying a semi-transparent rectangle object (e.g., HTML div element) that has the top-left vertex at the same (x1, y1) and bottom-right vertex at the same (x2, y2). An image area may contain one or more image objects and/or one or more text elements.

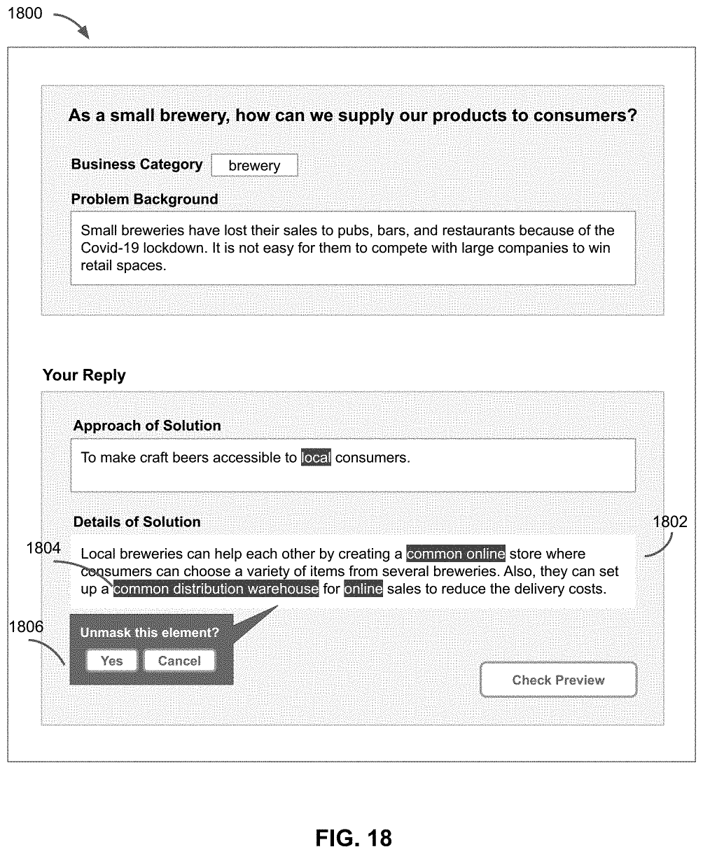

An example of a manual masking page consistent with an embodiment of the invention is shown and further described in connection with FIGS. 18 through 24.

After the user finishes specifying the desired set of candidate mask elements, by accepting his selection of a user interface element (e.g., button or link in the manual masking page), the online forum may lead the user to a confirmation page that provides him the ability to check the content where candidate mask elements are masked (masked content). In this invention, the term “mask” refers to any operation that makes the information in an element (e.g., piece of text, image area, audio segment or video segment) of a piece of content unrecognizable. For example, when an element is a piece of text or an image area, this operation may include, but is not limited to, covering the element with another image, obscuring the visualization of the element, or shuffling the letters (of the piece of text) or pixels (of the image area). When an element is a segment of audio, this operation may include, but is not limited to, replacing the audio segment with another audio segment, mixing the audio segment with another audio segment, or removing specific frequencies from the audio segment. When an element is a segment of video, this operation may include, but is not limited to replacing the video segment with another video segment, obscuring the visualization and/or sound of the video segment, or shuffling frames of the video segment.

Before leading the user to the confirmation page, at method operation 208, the online forum may generate masked content with the masked content generating module 114 and store it in the database(s), in the data store(s), or in file(s). Masked content is created using the original content and candidate mask elements. Example methods of creating masked content are described below in connection with their content type.

When the type of the content is text, the masked content can be generated as a text with markup tags (e.g., HTML tags) where candidate mask elements (that are pieces of text) are replaced with inline-block elements with no content in them such as “<span style=‘display:inline-block; width:100px; height:20px; background-colorblack’></span>” by referring to the position identifier (that is the starting position and the ending position of the piece of text) associated with each candidate mask element. The width, height, and the background-color of the inline-block elements can be changed. When text content with these markup tags is displayed in client applications (e.g., web browser, mobile application) the content is displayed with its candidate mask elements being replaced with rectangles where those widths, heights, and colors are specified in the markup tags. Alternatively, the masked content can be generated as an image file where candidate mask elements are replaced with rectangular image objects. An example of this process is described in the following steps using a third-party (or proprietary) image editing library.
[step 1] Remove all the candidate mask elements from the whole text content by referring to the position identifier associated with each candidate mask element.
[step 2] Split the text content into pieces by dividing it at positions where the candidate mask elements existed.
[step 3] Input each piece of text into a library image object one after another using an image editing library (e.g., Python Imaging Library) while adding a rectangle with a certain width, height, and color into the library image object between 2 consecutive pieces of text. (The term “library image object” refers to an image object generated by an image editing library. This term is used to differentiate from an “image object” in an image.) Positions of each piece of text and each rectangle should be adjusted so that they do not overlap each other and also that all of them stay in the range of the output image size.
[step 4] Output the library image object into an image file with the image editing library.

When the type of the content is an image (including diagrams) the masked content can be generated as an image file where candidate mask elements (each candidate mask element being an area of the image which includes one or more image objects and/or one or more text elements in the image) are covered with other image objects such as rectangle images. An example of this process is described in the following steps using a third-party (or proprietary) image editing library.
[step 1] Create a list of all candidate mask elements in the image and their position identifiers. Each position identifier is the set of vertices of each candidate mask element (image area).
[step 2] Load the original (unmasked) image file into a library image object using the image editing library (e.g., Python Imaging Library).
[step 3] Input rectangles, the areas and positions of which are specified by the position identifiers of the candidate mask elements, into the library image object. Stack orders (or z-indices) of these rectangles must be set greater than those of the candidate mask elements so that the candidate mask elements are covered by the rectangles. Also, the rectangles must be filled with non-transparent color to avoid the candidate mask elements being seen through them.
[step 4] Output the library image object into an image file with the image editing library.

When the type of content is audio, the masked content can be generated as an audio file where candidate mask elements (audio segments) are replaced by an arbitrary sound such as a “beep” sound. An example of this process is described in the following steps using a third-party (or proprietary) audio editing library.
[step 1] Create a list of all candidate mask elements in the audio and their position identifiers. Each position identifier is the starting time and the ending time of the segment.
[step 2] Load the original (unmasked) audio file into an audio object using the audio editing library.
[step 3] Remove each candidate mask element (audio segment) from the audio object by referring to the starting time and ending time of the segment and insert in its place an arbitrary sound (e.g., “beep” sound) for the same duration.
[step 4] Output the audio object into an audio file with the audio editing library.

When the type of content is video, the masked content can be generated as a video file where candidate mask elements that are video segments are replaced by arbitrary video segments such as a grey screen with a “beep” sound. Also, candidate mask elements that are areas of a video frame can be masked together with the video segments. An example of this process is described in the following steps using a third-party (or proprietary) video editing library.
[step 1] Create a list of all candidate mask elements in the video and their position identifiers. The position identifier of a video segment is the starting time and the ending time of the segment and the position identifier of an area of a video frame is the set of vertices of the image area.
[step 2] Load the original (unmasked) video file into a video object using the video editing library.
[step 3] Remove each candidate mask element (video segment) from the video object by referring to the starting time and ending time of the segment and insert arbitrary video segment (e.g., grey screen with “beep” sound) instead for the same duration. Also, in the video object, overlay rectangle images of those areas and positions specified by position identifiers of the candidate mask elements that are areas in a video frame. Stack orders (or z-indices) of these rectangles must be set greater than those of the candidate mask elements so that the candidate mask elements are covered by the rectangles. Also, the rectangles must be filled with non-transparent color to avoid the candidate mask elements being seen through them.
[step 4] Output the video object into a video file with the video editing library.

After the masked content is generated, the user may be directed to a confirmation page at method operation 210. At the confirmation page, the generated masked content is displayed thus enabling the user to confirm whether it indeed hides the key concepts that would lead information seekers to the understanding of the ideas or the knowledge contained therein while containing enough information to allow information seekers to determine whether the whole content is likely to include useful information that would be worth the payment of the rewards requested by the user. An example of a confirmation page consistent with an embodiment of the invention is illustrated in FIG. 25.

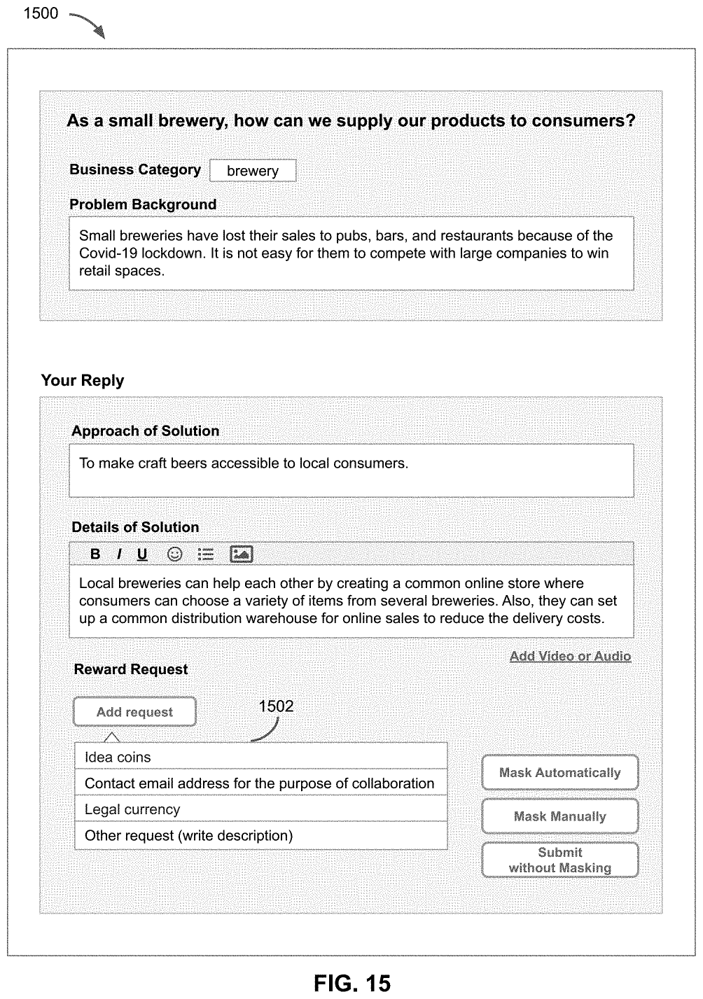

At the next method operation 212, an online forum may enable the user to choose either to accept or reject the masked content by selecting a user interface element (e.g., button or link). If the user rejects the masked content, the manual masking page may be displayed again so that the user can modify the set of candidate mask elements. If the user accepts the masked content, at method operation 216, an online forum enables the user to specify the rewards he requests in exchange for disclosing the whole of his content via a user interface element such as a text input box in which the user can describe rewards or via a select menu from which the user can select rewards from a list provided by an online forum. An example of a select menu consistent with an embodiment of the invention is shown at 1502 in FIG. 15. In some cases, users might not seek rewards in exchange for disclosing the whole content but might rather want to keep their content masked. In such cases, users do not have to specify rewards to post the content. One occasion for such a case is when a user wants to run a business using his ideas and wishes to receive investment for the business but desires to keep his ideas secret. When a user's masked content has enough information to convince investors that his business is worth investing in, the information holder has the chance to receive investment without disclosing the key concepts of his ideas necessary for solving the problems relating to the business. Although, in the above example, the user specifies the reward requests after the confirmation of his content, the specification can be accepted at any moment after the question page is presented to the users.

Lastly, at method operation 218 by accepting the user's selection of a user interface element (e.g., button or link in the confirmation page), the original (unmasked) reply content, the mask element(s) (elements to be masked), and the reward request(s) are posted to the online forum's server computer and stored in the database(s), in the data store(s), or in file(s).

After content is posted at method operation 218, when the content holder wishes to modify the set of mask elements and the masked content, the original (unmasked) content and the mask elements stored in database(s), data store(s), or in file(s) can be used to display the manual masking page again by highlighting the mask elements in the original content by referring to the position identifier of each mask element.

In some embodiments, mask elements are stored in a table in the database 122. An example of a mask element table 300 is shown in FIG. 3. In this example, each mask element is specified with element id 302, content id 304 identifying to which piece of content the mask element is associated, start position 306 identifying at what point the mask element starts in the content, end position 308 identifying at what point the mask element ends in the content, and time posted 310 identifying the time when the mask element is posted. Start position 306 and end position 308 are the factors of the position identifier for each mask element when the element is a text element (piece), an audio segment, or a video segment. When a mask element is an image area, the set of vertices of the area is its position identifier and it is stored in the mask element table instead of start position and end position as in the case of text elements, audio segments, or video segments.

The included features and the data structures of the features in the mask element table 300 may vary from the example shown in FIG. 3 as long as enough information is included to generate masked content together with the original piece of content.

In other embodiments, mask elements might be stored in the database as they are embedded in the original content as illustrated in a further example of a mask element table 320 in FIG. 3. In this example, mask elements are specified with element group id 322, content id 324 identifying to which piece of content the mask elements are associated, tagged content 326 identifying each mask element with “mask” tag in the content, and time posted 328 identifying the time when the mask elements are posted.

In some embodiments, reward requests are stored in a table in the database 122. An example of the reward request table 400 is shown in FIG. 4. In this example, each request is specified with request id 402, content id 404 identifying to which piece of content the request is associated, reward type 406, amount 408 identifying the amount that the user requests when the reward type is countable, and time posted 410 identifying the time when the request is posted. Some examples of reward types are legal currency such as USD, EURO, or GBP and cryptocurrencies such as Bitcoin or Ethereum. Another example of reward type is a token issued by the online forum. The token may be managed with the database of the online forum or it may be managed with a blockchain-based distributed system. A further example of reward type is the email address of an information seeker which would enable the information holder to communicate with the seeker with the intent of asking for collaboration or an investment in a business related to the information.

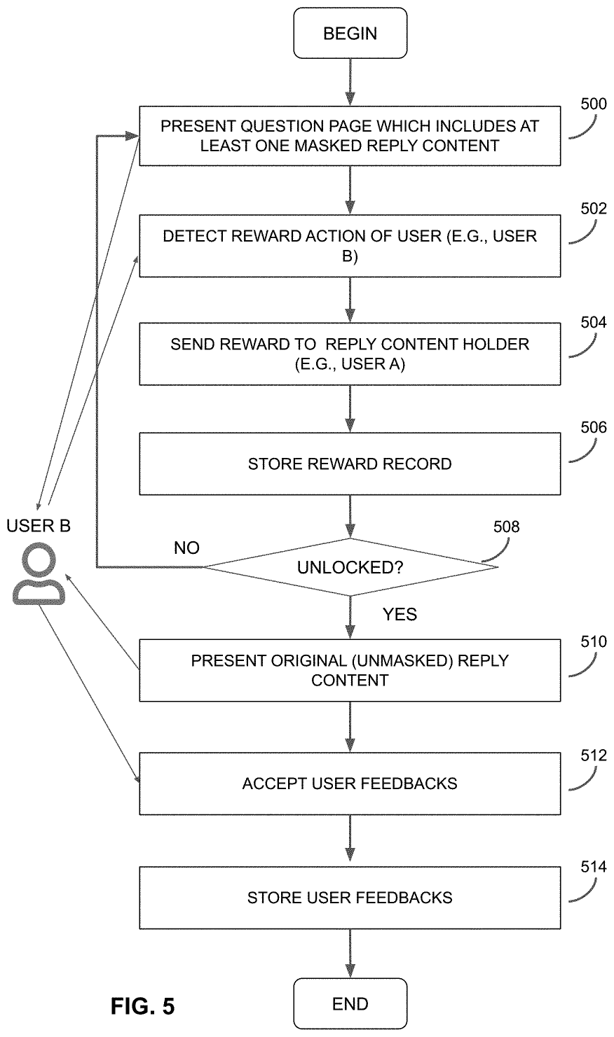

FIG. 5 is a flow diagram representing a method for enabling a user of an online forum to view a whole piece of reply content to a question without its elements being masked by granting the rewards that are requested by the replier in exchange for disclosing the whole reply content, consistent with embodiments of the invention.

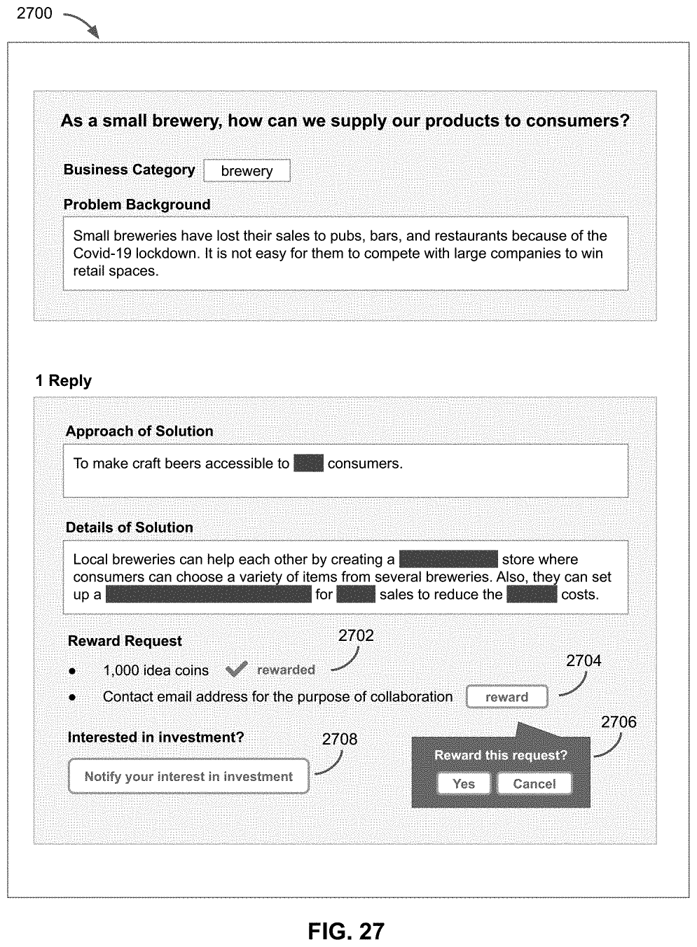

As illustrated in FIG. 5, the method begins at method operation 500 when an online forum presents to a user a question page for a question that has at least one piece of reply content with its element(s) masked (the masked content having been generated and stored in the database at method operation 208), displaying the reward requests that are associated with the respective reply content. An example of a question page with masked reply content is shown in FIG. 27. As illustrated in FIG. 27 the question page may have user interface elements such as buttons or links (e.g., element 2704 in FIG. 27) where each of them is associated with one of the displayed reward requests. For the purposes of this example, the user to whom the question page is presented is shown in FIG. 5 as “USER B”.

At method operation 502, the online forum detects an event or interaction with a user interface element associated with one of the displayed reward requests (e.g., element 2704 in FIG. 27) by a user (e.g., USER B). For example, in some embodiments, when a user selects a user interface element (e.g., button or link) on the question page that enables the user to make an action to reward the request, the selection is detected by the online forum when a request is communicated from the client application (e.g., a web browser application, mobile application) to the server on which the online forum resides.

After the user's selection is detected, at method operation 504, the online forum sends the reward to the reply content holder (e.g., USER A).

When the type of reward is a legal currency, the online forum may first accept the payment of the information seeker (e.g., USER B), then send the payment to the reply content holder interacting with any related third-party (or proprietary) modules (e.g., a third-party payment service). In some embodiments of the invention, the online forum may deduct a transaction fee from the payment before it is sent to the reply content holder.

When the reward is the email address of the information seeker (e.g., USER B) his email address may be delivered to the reply content holder via any messaging mechanisms such as email, SMS, or by showing it on a web page displayed to the content holder in the case that the information seeker's email address is registered to the database of the online forum. If the email address is not registered, however, the online forum may prompt the information seeker to provide his email address. For example, in some embodiments, the online forum presents a text box or some other user interface mechanism for receiving the email address through the operation of the user interface displayed at the client application. Once the information seeker's email address is received, the online forum will send it to the reply content holder as it was described.

When the reward is in the form of tokens issued by the online forum, the online forum may first check the balance of the tokens of the information seeker in the database and if it is sufficient for the amount requested by the content holder, then create a database transaction to deduct the amount from the information seeker's token balance and add the same amount to the content holder's token balance. If the information seeker's balance is not sufficient for the amount requested by the content holder, on the contrary, the online forum may notify that fact to the information seeker and prompt him to increase his token balance in the methods decided by the online forum such as purchasing the tokens or earning the tokens by contributive actions to the forum. In some embodiments of the invention, the online forum may deduct a portion of the requested tokens as a transaction fee before they are sent to the reply content holder.

After a reward request is fulfilled, at method operation 506, the online forum may store the reward record in a table in the database 122. An example of the reward record table 420 is shown in FIG. 4. In this example, each reward record is specified with a reward id 422, request id 424 identifying to which reward request the reward record is associated, “rewarded by” 426 identifying the user who fulfilled the reward request, and rewarded time 428 identifying the time when the reward request is fulfilled.

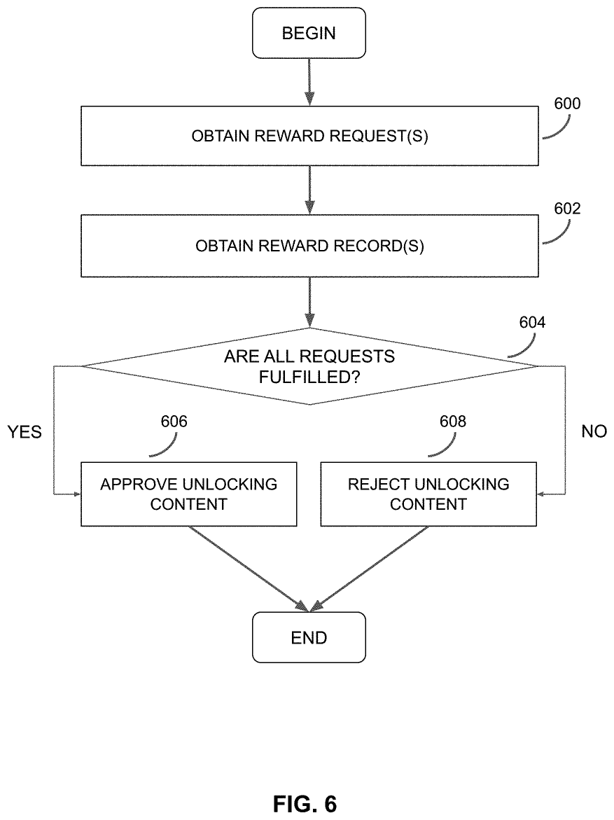

When a reward record is stored, at method operation 508, a determination is made as to whether the reply content is to be disclosed without its elements being masked to the information seeker. An example of the determination process is illustrated in FIG. 6.

At method operation 600, all reward requests associated with the reply content are retrieved from the reward request table 400, then at method operation 602, records of reward associated with the reply content that have been fulfilled by the information seeker (e.g., USER B) are retrieved from the reward record table 420. After these operations, at method operation 604, a determination is made as to whether all reward requests have been fulfilled by the information seeker by referring to the retrieved reward records. If all reward requests have been fulfilled, then a determination to disclose (unlock) the reply content is made at method operation 606, if not, a determination not to disclose (unlock) is made at method operation 608.

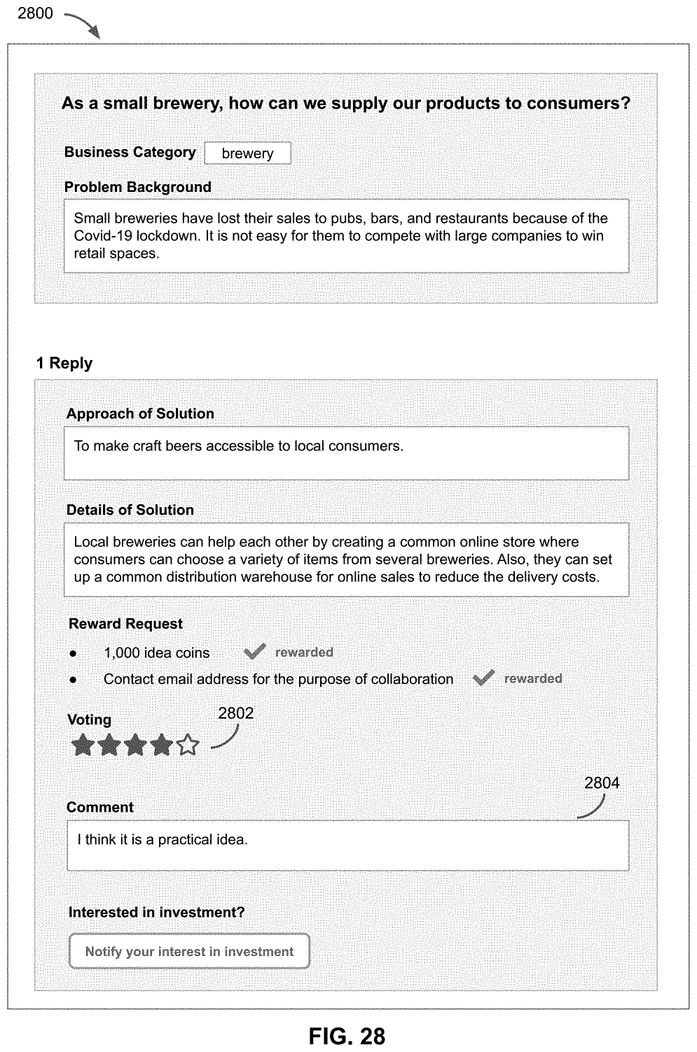

Referring again to FIG. 5, if the reply content is unlocked, at method operation 510, the original (unmasked) reply content is presented to the information seeker. An example of a question page with its reply content unlocked is illustrated in FIG. 28. If the reply content is not unlocked, on the contrary, the masked reply content continues to be displayed on the question page.

After the original (unmasked) reply content is presented, at method operation 512, the online forum may accept an information seeker's feedbacks such as a user rating (voting) and/or comments via user interface elements (e.g., clickable images 2802 or a text input box 2804 in FIG. 28).

Finally, at method operation 514, any feedbacks are stored in user feedbacks 134 in the database 122.

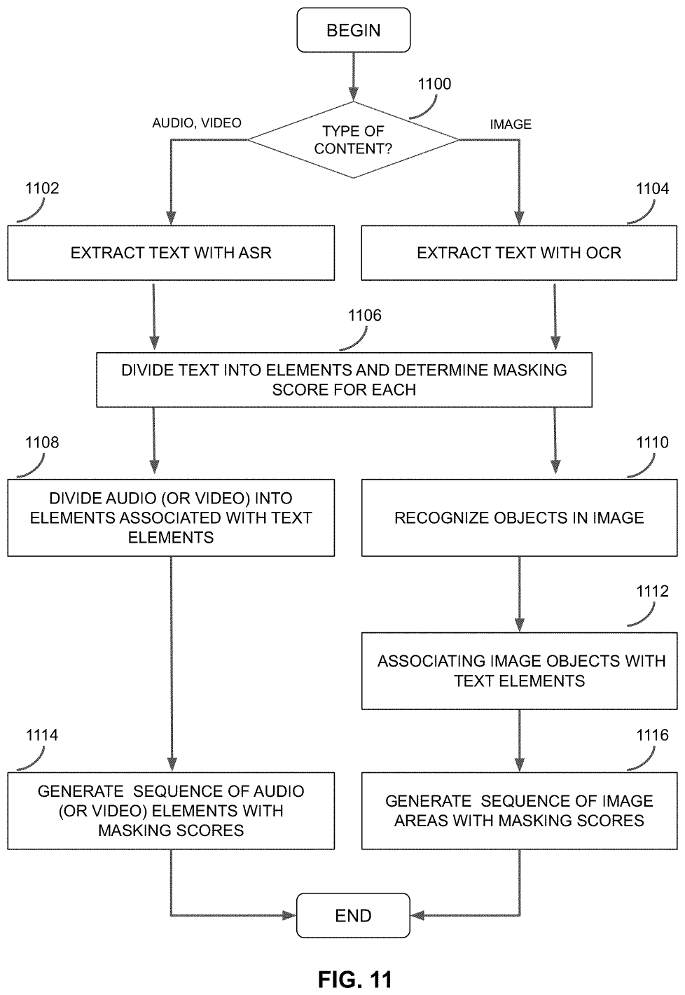

FIG. 7 is a flow diagram representing a detailed process of method operation 204 where the online forum determines the candidate mask elements in the reply content. As illustrated in FIG. 7, the method begins at method operation 700 when automatic content masking module 112 receives the original (unmasked) reply content. At this method operation, the module may receive a specification of the degree of masking (e.g., “20”, meaning that 20 percent of the content should be selected as candidate mask elements automatically.) from a content holder (e.g., USER A) via a user interface element as an optional input. At method operation 700, the online forum may receive various types of input data such as text, diagram images, pictures, audio data, or video data, but the process at method operations 702 and 704 in the case of text input data will be described firstly, then the equivalent processes in the case that the input data is an audio, a video, or an image will be described later in connection with FIG. 11.

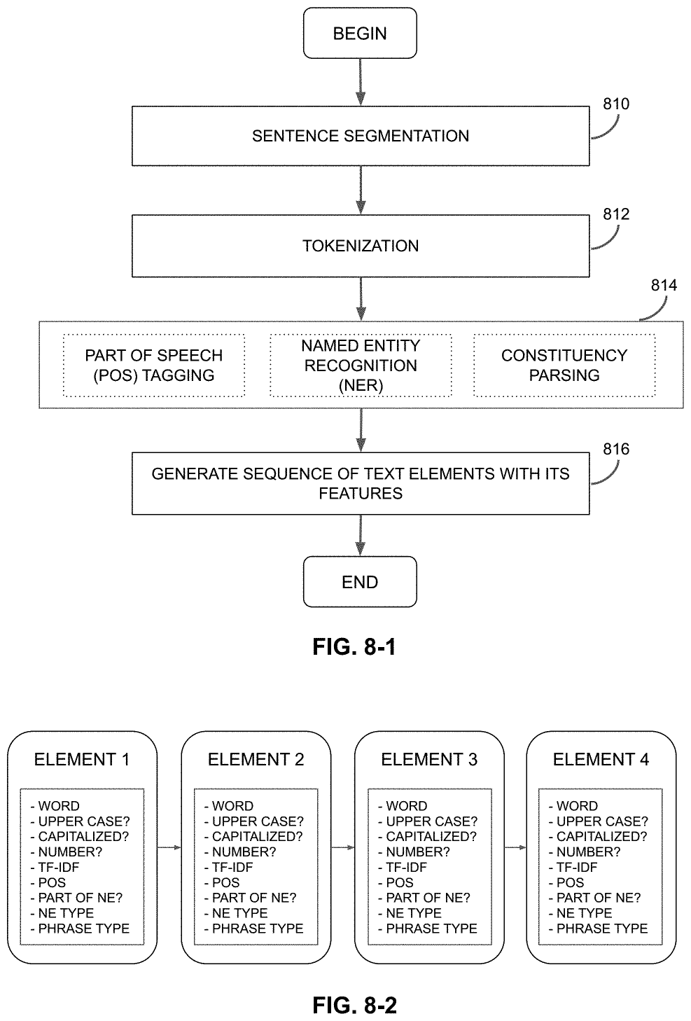

At method operation 702, the module divides text input into elements in preparation for the subsequent process. FIG. 8-1 is a flow diagram representing an example of a detailed process of method operation 702. At method operation 810 in FIG. 8, the text input is segmented into sentences, then at method operation 812, each sentence is tokenized into words to generate word sequence. After the tokenization, at method operation 814, natural language processing (NLP) operations such as part of speech (POS) tagging, named entity recognition (NER), and constituency parsing are applied to each word sequence. While POS tagging is an operation to extract a feature for each word, NER and constituency parsing are used to extract larger syntactic chunks such as named entities and phrases along with the types of those chunks (e.g., class of NE (Named Entity), type of phrase). After these NLP operations, at method operation 816, a sequence of text elements is generated where each element is accompanied by its features.

Each text element may be, but is not limited to, a word, a NE, or a phrase. An example of the sequence of text elements is illustrated in FIG. 8-2 where each element is a word. Each element may have features such as “WORD” (e.g., “Orange”), “UPPER CASE?” (e.g, “no”) meaning whether all letters in the word are in upper case, “CAPITALIZED?” (e.g., “yes”) meaning whether the first letter of the word is in upper case, “NUMBER?” (e.g., “no”) meaning whether the word includes numerals, “POS (part of speech)” (e.g., “NOUN”), “PART OF NE?” (e.g., “yes”) meaning whether the word is a part of a NE (e.g., “Orange Inc.”), “NE TYPE” (e.g., “Organization”) meaning the type (or class) of the named entity to which the word belongs, “PHRASE TYPE” (e.g., “NOUN PHRASE”) meaning the type of the phrase to which the word belongs. “TF-IDF (term frequency-inverse document frequency)” (e.g., “2.5”) is a numerical statistic that is intended to reflect how important the word is to the content. The calculation method of TF-IDF may take several forms. One exemplary form of the calculation method is tf−idf=tf*log(N/df), where tf is the number of times the word occurs in the content, df is the number of pieces of content (in an online forum) in which the word occurs, and N is the total number of pieces of content in an online forum. A word, in a piece of content, has a large TF-IDF value if it occurs rarely (less frequently) in the set of pieces of content to which the piece of content belongs whilst being mentioned frequently in the piece of content. Therefore, such a word tends to be used to present the information that makes the piece of content unique which the content holder wishes to hide from information seekers to keep them from understanding the key concepts of the content. In some embodiments of the invention, an online forum may use any other numerical statistic that is similar to TF-IDF.

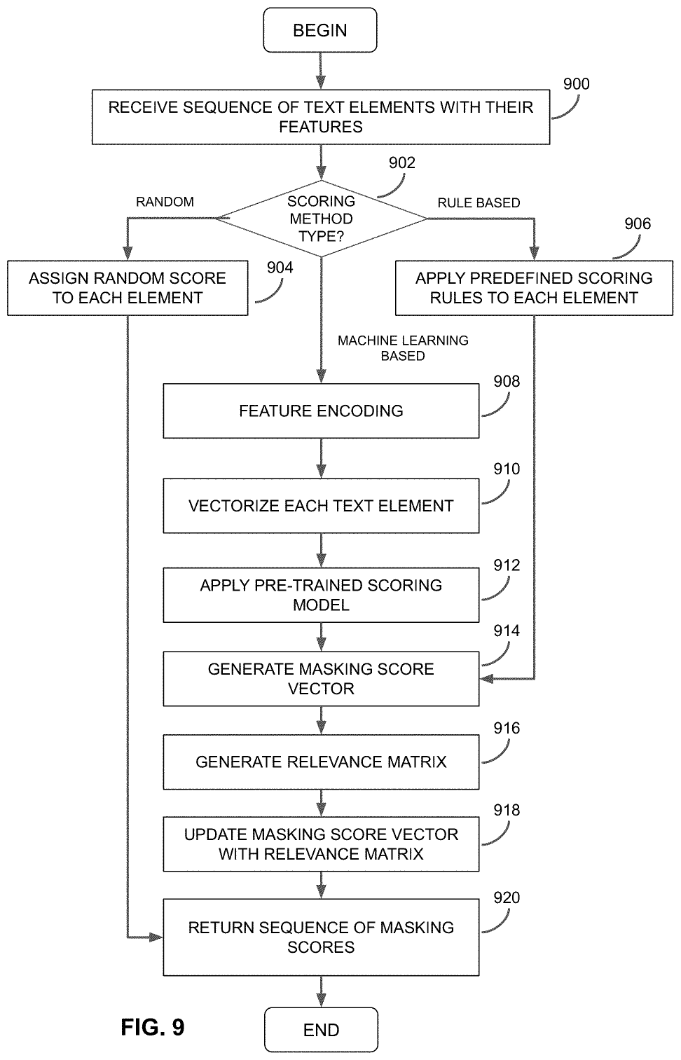

After the content is divided into elements, at method operation 704 in FIG. 7, automatic content masking module 112 generates a masking score for each element. FIG. 9 is a flow diagram representing the detailed process of method operation 704.

In FIG. 9, three example scoring methods based on different approaches are illustrated and these processes may be executed by a submodule of automatic content masking module 112. Whilst how to combine (or subdivide) the processes is not the scope of the invention, a submodule of automatic content masking module 112 is introduced to explain the process in FIG. 9.

In FIG. 9, all of the three different scoring methods begin at method operation 900 where the submodule of automatic content masking module 112 receives the sequence of text elements where each element is accompanied by its features.

When the scoring method is based on a random approach, at method operation 904, the submodule assigns a random score (e.g., any numeric value between 0 to 1) to each text element. When the scoring method is based on a rule approach, at method operation 906, the submodule assigns a score to each text element based on the manually predefined scoring rules.

An example process of the rule-based scoring for each text element is, in the case of a text element being a word, to sum up all scores where each score is determined by each scoring rule. When the text element is a larger unit such as a NE, phrase, or sentence, the score of the text element can be calculated by summing up the scores of all the words that are included in the text element or alternatively, the average of the scores of all the words included in the text element may be used as its score.

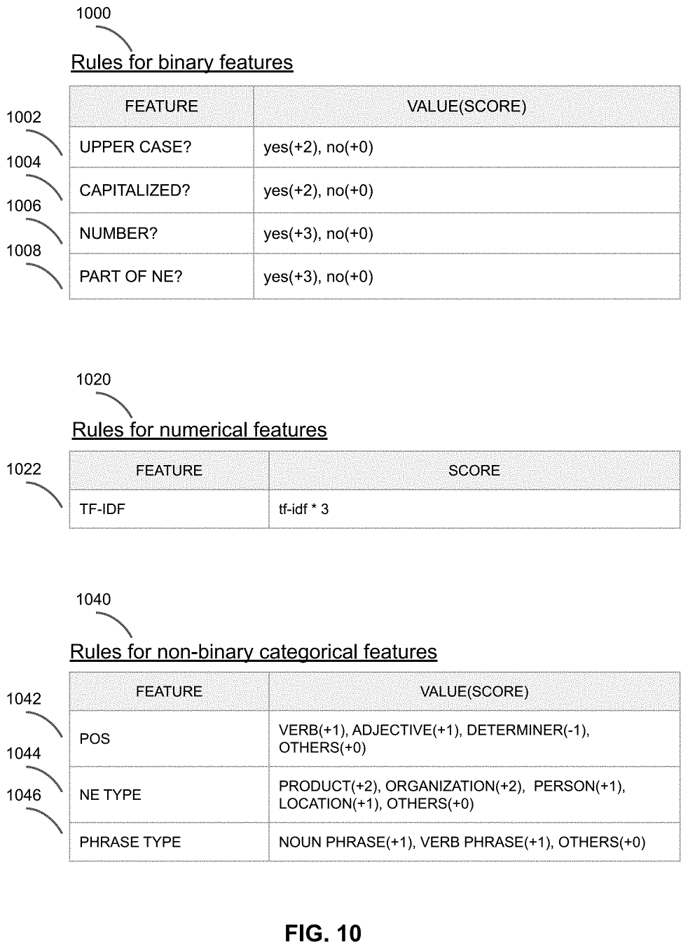

Examples of scoring rules for scoring a word consistent with an embodiment of the invention are illustrated in FIG. 10.

Rules for binary features 1000 are to determine scores for features that have 2 possible values namely “yes” or “no”. For example, when any letter in a word is in lower case (The value of “UPPER CASE?” is “no”) the score for the word would not be changed by the “UPPER CASE?” rule 1002. Likewise, when the first letter of a word is in upper case, (the value of “CAPITALIZED?” is “yes”) the score for the word would be increased by 2 by the “CAPITALIZED?” rule 1004.

Rules for numerical features 1020 are to determine scores for features that have a numerical value (e.g., “2.5”). For example, when a feature is TF-IDF, the score for a word would be increased by the output of the rule's function that takes the TF-IDF value as its input such as F(tf-idf)=tf-idf*3 by the “TF-IDF” rule 1022.

Rules for non-binary categorical features 1040 are to determine scores for categorical features that have more than 2 possible values. An example of a non-binary categorical feature is POS (part of speech) which has values such as “NOUN”, “VERB”, “ADJECTIVE”, etc. For example, when the POS of the word is determiner, the score for the word would be decreased by 1 by the “POS” rule 1042.

Referring again to FIG. 9, when the scoring method is based on a machine learning approach, at method operation 908, the submodule may encode categorical features of a text element into numerical features so that machine learning algorithms can process them.

When a categorical feature is a binary feature having 2 possible values namely “yes” or “no”, these values may be encoded by changing “yes” to “1” and “no” to “0”.

When a categorical feature has more than 2 possible values, as is the case of POS, it can be encoded with One Hot Encoding. For example, the feature for POS can be encoded into a vector of binary value (either “0” or “1”), as set forth below, where the length of each vector is the number of POS types.
When the POS is “NOUN”: (1, 0, 0, 0 . . . )
When the POS is “VERB”: (0, 1, 0, 0 . . . )
When the POS is “ADJECTIVE”: (0, 0, 1, 0 . . . )

When a categorical feature is a word itself, it can be encoded likewise with One Hot Encoding, or it can be encoded by any word embedding algorithm such as word2vec with which a word can be encoded into a fixed-length vector of numerical values.

When a categorical feature is a sequence of words including more than one word such as a NE (Named Entity), phrase, or a sentence, it can be encoded by any algorithm that is capable of encoding a word sequence into a fixed-length vector of numerical values such as a long short term memory (LSTM) network or doc2vec.

When a feature has a numerical value such as TF-IDF, the value can be used without encoding.

After categorical features are encoded into numerical features, at method operation 910 each text element may be vectorized into a vector which can be generated by aggregating the values of numerical features and encoded categorical features, then at method operation 912, a pre-trained scoring model is applied to each generated vector to predict a masking score for each text element.

In some embodiments of the invention, the pre-trained scoring model can be created with any machine learning classification algorithm able to generate confidence values for classification classes such as Random Forest, Logistic Regression, or Neural Network, by training the model with a labeled training data set.

Labeled data of a text element in the training data set is composed of the vector which represents feature values of the text element generated at method operation 910 and the label (either 0 or 1) generated by a human labeler specifying whether the text element is to be masked (labeled 1) or not (labeled 0).

Once the model is trained, it can be used to classify whether a text element should be masked or not at method operation 912. During the classification process, the confidence values for classification classes (class A: the text element should be masked, class B: the text element should not be masked) can be calculated and the confidence value for class A (the text element should be masked) can be used as the masking score of the text element.

In the above embodiments, the machine learning algorithm receives input data where each data instance is associated with one text element but in other embodiments, method operation 912 can use any machine learning algorithm that receives input data where each data instance is associated with a sequence of text elements and executes structured learning/prediction such as conditional random fields (CRFs). By using such an algorithm, the machine learning model can predict the series of classes, where each class is either class A (the text element should be masked) or class B (the text element should not be masked), by taking into account the dependencies between the classes of text elements in the sequence. At the same time, It can also generate the confidence value of each text element being classified into class A (the text element should be masked) which can be used as the masking score of the text element.

Although the masking scores generated at method operation 912 can be used as the output of the submodule, they may be corrected by the submodule in the latter method operations in FIG. 9 that are described below.

At method operation 914, a vector composed of masking scores (masking score vector) may be created by collecting the masking score for each text element, then, at method operation 916, the relevance matrix R indicating the relevance between any pair of text elements in the content may be created.

While relevance value r(i,j) identifying the relevance between an i-th element and a j-th element in matrix R can be calculated in various ways, in some embodiments, it may be calculated by pointwise mutual information such as r(i,j)=PMI(i,j)=log(P(i,j)/(P(i)*P(j))) where P(i,j) is the probability of co-occurrence of i-th and j-th elements, P(i) and P(j) are the probabilities of occurrence of i-th and j-th elements in a text corpus.

In other embodiments, the relevance value r(i,j) may be calculated by the cosine similarity of the embedding vectors of the i-th and j-th elements where each embedding vector is generated by any word embedding algorithm such as word2vec, or it may be generated by any algorithm capable of vectorizing a word sequence such as a long short term memory (LSTM) network or doc2vec in the case of a text element comprising a larger unit such as a NE, phrase, or sentence. After every element of the matrix is calculated, each column of the matrix may be normalized (divided) by its sum.

After the relevance matrix R is generated, at method operation 918 the masking score vector is updated as v′=Rv where v is the masking score vector and v′ is the updated vector. The k-th value of the updated vector identifies the updated masking score of the k-th element which is updated by taking into account the relevance between the k-th element and other elements.

Finally, at method operation 920, the submodule returns the updated masking score vector which indicates the masking score of each text element to the parent module (automatic content masking module 112) at method operation 704 in FIG. 7.

Method operations 702 and 704 are described above in the case of reply content in the form of text but the equivalent process in the case of reply content in the form of audio, video, or image is illustrated in FIG. 11.

When the content is audio or video, at method operation 1102, text information is extracted from the audio or video by an automatic speech recognition (ASR) system. When the content is an image(which term also refers to a diagram or a video frame), at method operation 1104, text information is extracted from the image using an optical character recognition (OCR) system. In some embodiments of the invention, an online forum may use a third-party ASR (or OCR) system or it may use a proprietary system instead.

After the text information is extracted, at method operation 1106, it is divided into text elements and the masking score is determined to each of them by following the process described in FIG. 8-1 and FIG. 9. After the text information is processed, at method operation 1108, the audio (or video) content is divided into elements (segments of the content) associated with their text elements by referring to the timestamps of the ASR output that identify how much time has passed since the beginning of the content. For example, the i-th element of the audio (or video) content is extracted by referring to the starting time of the i-th text element and the ending time of the i-th text element. By applying this analysis, the audio (or video) content is divided into the same number of elements as the number of text elements where each audio (or video) element is associated with one text element.

When the content is an image, at method operation 1110, objects in the image are recognized by a third party (or proprietary) image recognition tool and, at method operation 1112, associations are made between the image objects and text elements in the image which have been extracted by OCR. In some embodiments of the invention, each image object is associated with the nearest text element by calculating the euclidean distance between the center of the image object and the center of each text element. The text element that has the shortest Euclidean distance is chosen to be associated with the image object. In this process, multiple image objects might be associated with one text element.

At the final method operation 1114, in the case where the content type is audio or video, a sequence of audio (or video) segments is generated where the i-th segment of the content has a masking score of the i-th text element. Each audio (or video) segment in the sequence is identified with the starting time and the ending time of the segment.

At the final method operation 1116, in the case where the content type is an image, a sequence of image areas (where each area is the area of the smallest rectangle that contains each image object or each text element in the image) is generated. Each image area in the sequence is accompanied by the masking score of the text element that is associated with the image object in the area in the case that the area contains an image object. When an area contains a text element, the masking score of the area is the masking score of the text element. Also, each image area is identified by its vertices.

Thus far example processes of extracting elements with masking scores from content in various types such as text (including text in images), image (including diagram and video frame), audio, and video have been described.

Now referring again to FIG. 7, at method operation 706, candidate mask elements of the content are determined using the masking scores that are assigned to each element. Since the final decision of whether these elements are to be masked in the content is decided by the content holder at method operation 212 in FIG. 2, these are the candidates for mask elements. When a degree of masking was specified by the content holder, at method operation 700, the online forum determines the candidate mask elements in accordance with the degree. For example, if the degree is “20”, the 20 percent of elements having the highest masking scores are chosen as the candidate mask elements. If the degree is not specified by the content holder, the online forum may use a default degree (e.g., “30”) predefined by the online forum.

FIGS. 12 through 28 are user interface diagrams illustrating examples of various user interfaces, and portions of user interfaces for use with an online forum consistent with embodiments of the invention. The examples of user interfaces and portions of user interfaces shown in FIGS. 12 through 28 are provided to convey an understanding of the inventive concepts described herein, and a particular context in which the inventive subject matter might be implemented. It will be readily appreciated by skilled artisans that the user interfaces illustrated herein are examples and that user interfaces differing from those illustrated herein may be applicable to the inventive concepts described herein.

FIG. 12 illustrates an example of a piece of content corresponding to a question page 1200 posted on a network-based or web-based online forum by a user (questioner). The question page contains question area 1202 including a question 1204 (“As a small brewery, how can we supply our products to consumers?”), a business category (specified by the questioner) 1206 associated with the question, and problem background 1208 describing the background to the question. The question page 1200 permits the viewing user to add reply content to the posted question in reply area 1210 including text input boxes for the approach of the solution 1212 and for the details of the solution 1214. The image icon 1216 provides the user with the ability to insert images in addition to text content in the solution details 1214. In addition, or as an alternative, by selecting the button or link 1218 with the text “Add Video or Audio”, a replier may add video or audio content as part of the reply content. In the example given in FIG. 12, buttons 1220, 1222, 1224, 1226, and toggle switch 1228 are not selectable because reply content has not been added yet. When reply content is added by a replier, the online forum detects it and makes 1220, 1222, 1224, 1226, and 1228 selectable enabling the replier to make further actions. This manipulation of the buttons or the toggle switch can be achieved by executing the function or code (e.g., javascript function) running on the client-side application (e.g., web browser application) that changes their states from unselectable to selectable.

FIG. 13 illustrates an example of a piece of reply content that has been filled in the reply area 1302 on a question page 1300. In this example, buttons 1308, 1310, 1312, 1314, and toggle switch 1316 are selectable because solution approach 1304 and solution detail 1306 have been filled in.

The button 1308 with the text “Mask Automatically” is for requesting the online forum first to detect candidate mask elements automatically as its example process is shown in FIG. 7, and then to lead the replier to a manual masking page.

The button 1310 with the text “Mask Manually” is for requesting the online forum to lead the replier to the manual masking page without detecting candidate mask elements automatically.

The button 1312 with the text “Submit without Masking” is for requesting the online forum to lead the replier to the confirmation page directly without masking any elements.

The button 1314 with the text “Add request” is for requesting the online forum to suggest a list of rewards enabling the replier to choose rewards to accept in exchange for disclosing the whole reply content to other users.

The toggle switch 1316 is for requesting the online forum to notify other users that the replier is seeking investment for the idea that is presented in the reply area 1302. The notification may appear with the masked reply content on the online forum after the content is posted or it may be sent by emails to users who are interested in the same business category (their interested categories are to be inquired of and registered to the database of the online forum beforehand) though the means of the notification are not limited to these.

An example list of rewards is shown with reference number 1502 in FIG. 15.

“Idea coins” represents tokens issued by the online forum. When the replier selects this button or link, the online forum detects it and displays a numerical value input box enabling him to specify the amount of the tokens to receive.

“Contact email address for the purpose of collaboration” represents the email address of the user who seeks to view the whole reply content (information seeker).

“Legal currency” represents currencies such as USD, EURO, or GBP. When the replier selects this button or link, the online forum detects it and displays a user interface element (e.g., a selectable drop-down list) enabling him to specify the currency along with a numerical value input box enabling him to specify the amount of the currency to receive.

“Other request (write description)” is for enabling the replier to specify a reward other than the suggested ones by filling in a description in a text input box which appears when this button or link is selected.

FIG. 14 illustrates an example of reply content 1400 where solution detail 1402 includes an image 1404 and a video 1406 as part of the reply content.

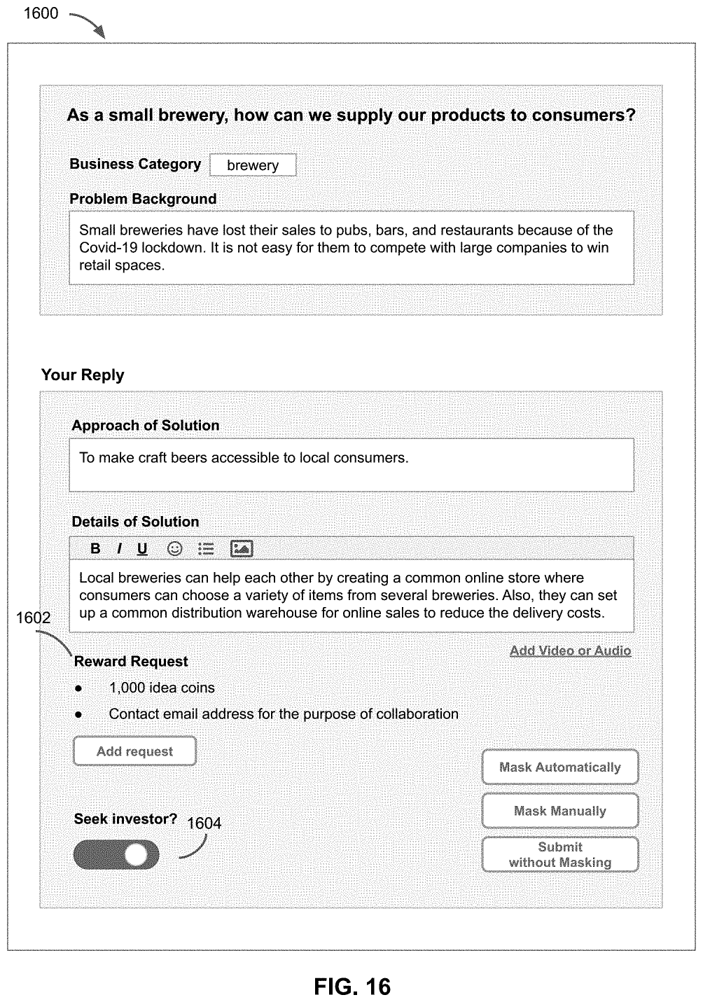

FIG. 16 illustrates an example of a question page 1600 with reply content before its mask elements (and candidate mask elements) are specified, where 2 rewards “1,000 idea coins” and “Contact email address for the purpose of collaboration” are specified at reward requests 1602, and toggle switch 1604 is turned on to notify other users that the replier is seeking investments to develop the idea.

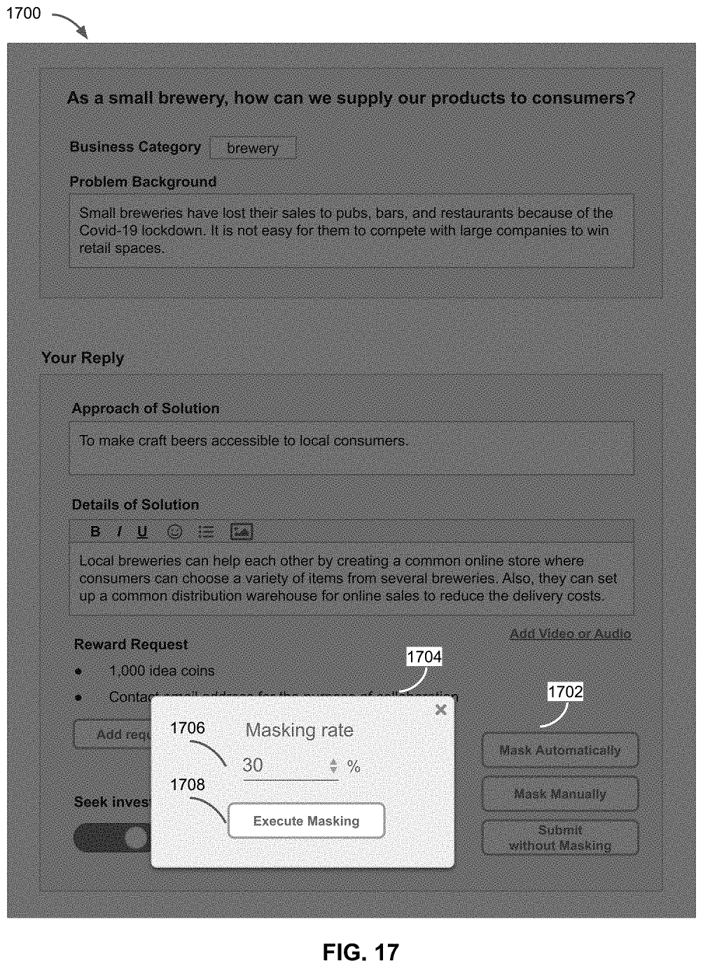

FIG. 17 illustrates an example of a question page 1700 with reply content before its mask elements (and candidate mask elements) are specified where a pop-up window 1704 is displayed because the “Mask Automatically” button (or link) 1702 has been selected. In the pop-up window 1704, the numerical value input box 1706 provides the replier with the ability to specify what percentage of the content is to be selected as candidate mask elements (masking degree) in the case that he wants to change the default masking degree (e.g., “30”) presented by the online forum. The button 1708 enables the replier to request the online forum to determine candidate mask elements automatically with either the specified or the default masking degree.

FIGS. 18, 19, 20, 21, 22, 23, and 24 illustrate examples of manual masking pages where the replier can interact with the user interface elements of the page to manually specify the candidate mask elements. The replier may remove and change the range (or area) of the candidate mask elements that are determined at method operation 204 and in addition, he can add new candidate mask elements in the manual masking page. Before referring to each figure, the mechanism that provides the replier with the ability to achieve these operations will be described below in the case of the client application being a web browser application, although the type of client application, in the invention, is not limited to web browser applications.

When a user interacts with interface elements of a web page on an online forum, the online forum can run specific functions (or pieces of code) on the user's web browser application, that are written in a client-side scripting language such as Javascript, in response to the specific events that are initiated by the user's interactions. The client-side functions (or pieces of code) are downloaded to the user's client computer from the online forum's server computer when the web browser requests a web page from the online forum. The examples of combinations of an event, user action(s) which initiate the event, and function(s) that are caused to run by the event are described below without the embodiments of the invention being limited to these examples.

Example 1 (To confirm whether a candidate mask element that has been selected is to be removed.):
Event:
   Selection of a candidate mask element that may be a piece of text, an image area, an audio segment, or a video segment.
User action(s):
   Moving the cursor over the element by a mouse device (or a touch panel) and clicking the left button of the mouse device (or tapping on a touch panel).
   Touching the element on a touch screen.
Function(s):
   Presenting a pop-up window to confirm whether the element is to be removed.

Example 2 (To remove the candidate mask element after confirmation.):
Event:
   Selection of a confirmation button on a pop-up window.
User action(s):
   Moving the cursor over the confirmation button by a mouse device (or a touch panel) and clicking the left button of the mouse device (or tapping on a touch panel).
   Touching the confirmation button on a touch screen.
Function(s):
   Manipulating the content to remove the markup tag (e.g., HTML tag) or the semi-transparent rectangle object (e.g., HTML div element) that is used to specify the element as a candidate mask element and to differentiate the presentation of it from the other elements that are not candidate mask elements.

Example 3 (To confirm whether a piece of text that has been selected is to be added into the set of candidate mask elements.):
Event:
   Selection of a piece of text.
User action(s):
   Pressing the left button of a mouse device (or a touch panel) and then moving the cursor over the desired text.
   Pressing a part of a touch screen and then sliding the handles that are presented by the web browser application to include the desired text.
Function(s):
   Presenting a pop-up window to confirm whether the piece of text that is selected is to be added into the set of candidate mask elements.

Example 4 (To confirm whether an area of an image that has been selected is to be added into the set of candidate mask elements.):
Event:
   Selection of an area of an image.
User action(s):
   Pressing the left button of a mouse device (or a touch panel) and then moving the cursor so that the rectangle which has the track of the cursor as its diagonal covers the desired area.
   Pressing a part of a touch screen and then moving the finger so that the rectangle which has the track of the touching point as its diagonal covers the desired area.
Function(s):
   Presenting a pop-up window to confirm whether the area of an image that is selected is to be added into the set of candidate mask elements.

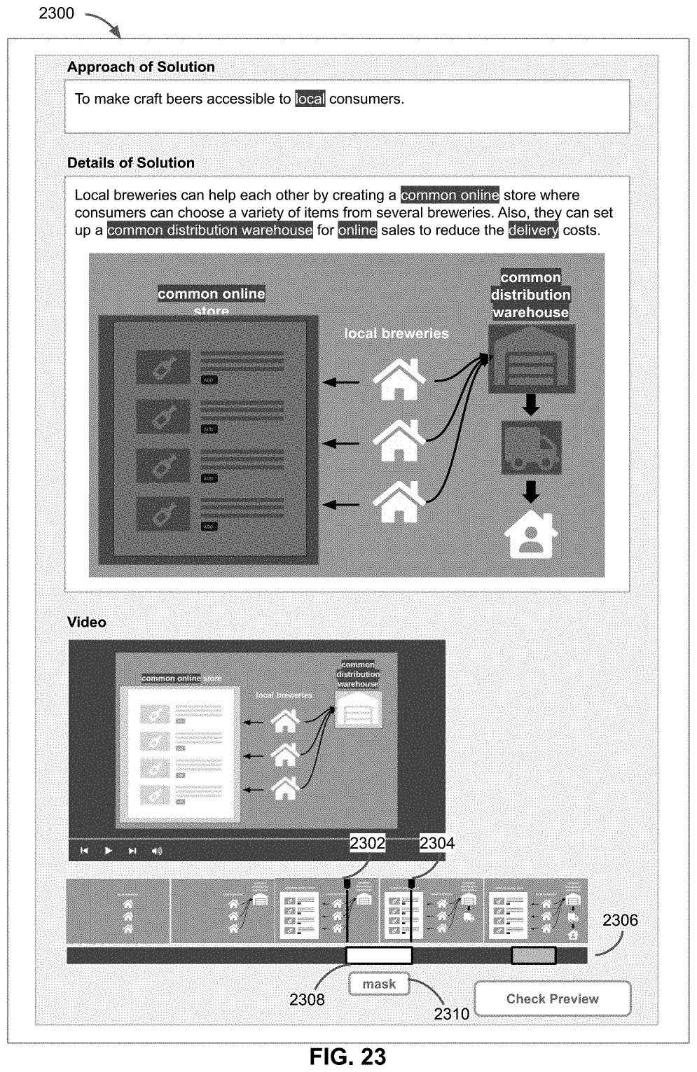

Example 5 (To confirm whether an audio segment or a video segment that has been selected is to be added into the set of candidate mask elements.):
Event:
   Selection of an audio segment or a video segment.
User action(s):
   Sliding the handles on the progress bar (e.g., left handle 2302 and right handle 2304 in FIG. 23) to include the desired audio (or video) segment.
Function(s):
   Presenting a button (e.g., button 2310 in FIG. 23) to confirm whether the audio (or video) segment that is selected is to be added into the set of candidate mask elements.

Example 6 (To add a selected element that may be a piece of text, an area of an image, an audio segment, or a video segment into the set of candidate mask elements after confirmation.):
Event:
   Selection of a confirmation button.
User action(s):
   Moving the cursor over the confirmation button by a mouse device (or a touch panel) and clicking the left button of the mouse device (or tapping on a touch panel).
   Touching the confirmation button on a touch screen.
Function(s):
   Manipulating the content to add a markup tag (e.g., HTML tag) that is used to specify the element to be a candidate mask element and to differentiate the presentation of it from the other elements that are not candidate mask elements in the case where the selected element is a piece of text.
   Manipulating the content to add a semi-transparent rectangle object (e.g., HTML div element) over the selected element in the case where the selected element is an area of an image or an audio (or video) segment on the progress bar.
   When the area (or range) of the selected element overlaps with the area (or range) of an existing candidate mask element, first removing the markup tag (in the case where the selected element is a piece of text) or the semi-transparent rectangle object (in the case where the selected element is an area of an image or an audio (or video) segment on the progress bar) and adding the new one which is specified with the selected area (or range).

FIG. 18 illustrates an example of a manual masking page 1800 with reply content where candidate mask elements are highlighted. In FIG. 18, a pop-up window 1806 is displayed when one of the candidate mask elements 1804 is selected in the solution detail 1802. The pop-up window 1806 provides the replier with the ability to remove the selected element from the set of candidate mask elements so that it will not be masked.

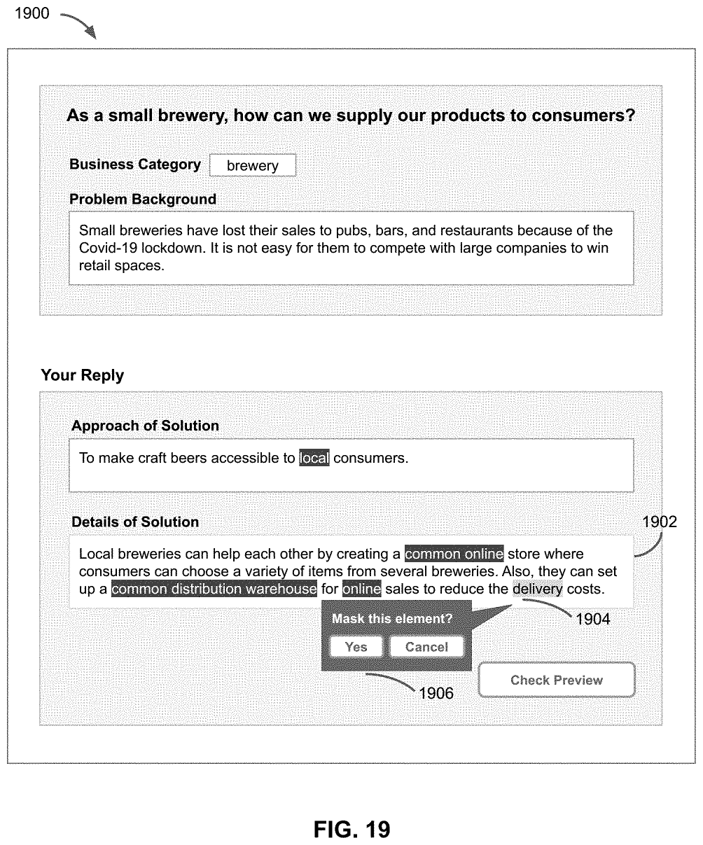

FIG. 19 illustrates an example of a manual masking page 1900 with reply content where candidate mask elements are highlighted. In FIG. 19, a pop-up window 1906 is displayed when the online forum detects the replier's text selecting action in solution detail 1902. The pop-up window 1906 provides the replier with the ability to add the selected piece of text 1904 to the set of candidate mask elements so that it will be masked.

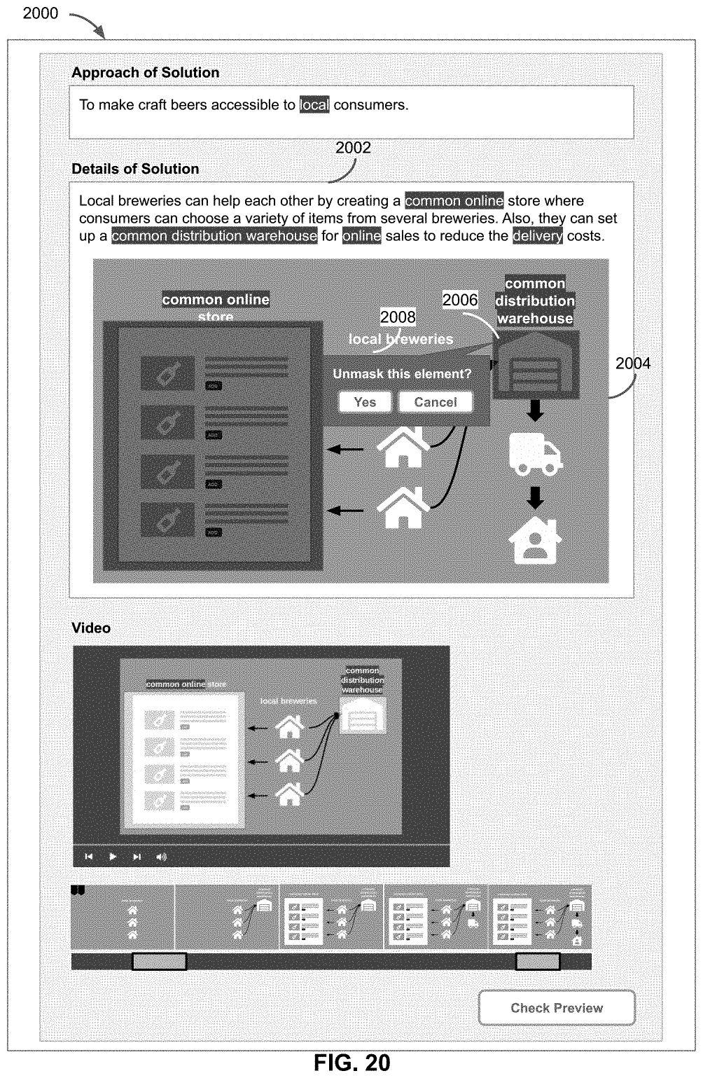

FIG. 20 illustrates an example of a manual masking page 2000 where solution detail 2002 includes an image 2004 with its candidate mask elements including text elements and image areas highlighted. In FIG. 20, a pop-up window 2008 is displayed when one of the image areas 2006 that is a candidate mask element is selected. The pop-up window 2008 provides the replier with the ability to remove the selected image area 2006 from the set of candidate mask elements so that it will not be masked.

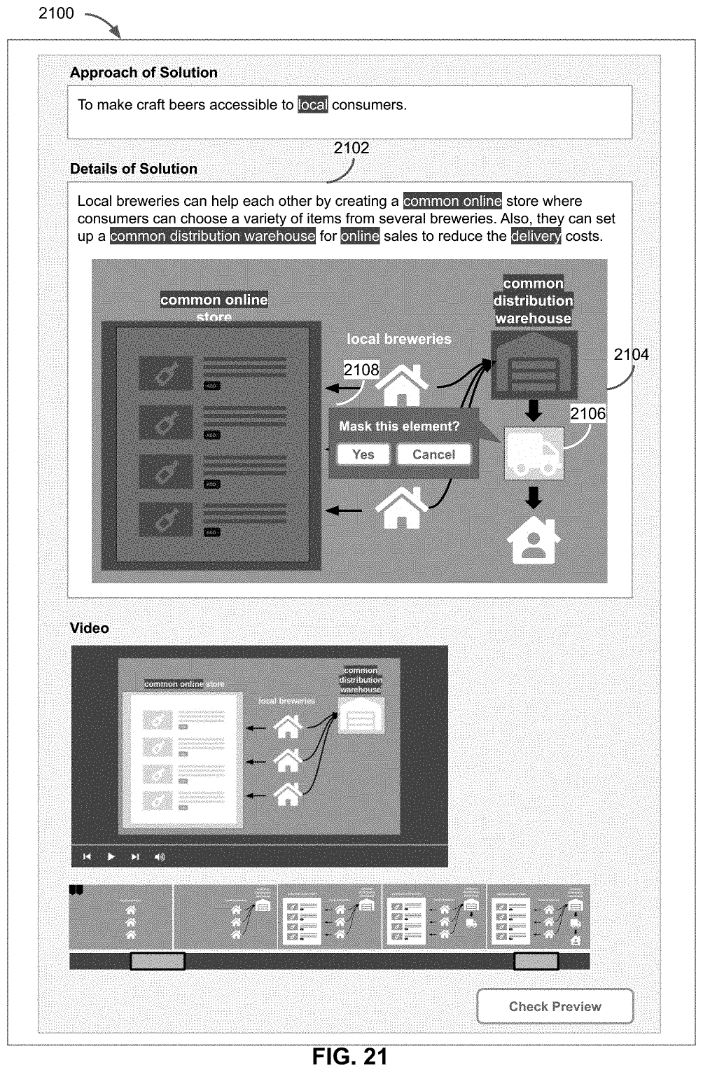

FIG. 21 illustrates an example of a manual masking page 2100 where solution detail 2102 includes an image 2104 with its candidate mask elements including text elements and image areas highlighted. In FIG. 21, a pop-up window 2108 is displayed when the online forum detects the replier's action of selecting an image area. The pop-up window 2108 provides the replier with the ability to add the selected image area 2106 to the set of candidate mask elements so that it will be masked.

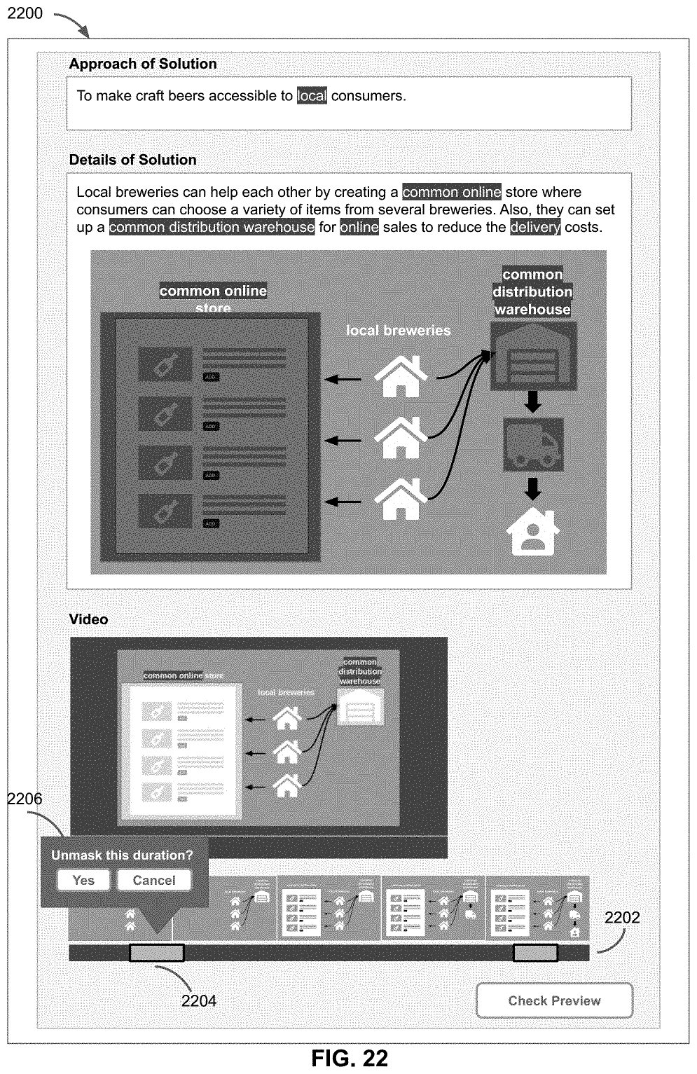

FIG. 22 illustrates an example of a manual masking page 2200 including video content where some durations of it are highlighted as candidate mask elements on the video progress bar 2202. In FIG. 22, a pop-up window 2206 is displayed when one of the highlighted durations 2204 is selected. The pop-up window 2206 provides the replier with the ability to remove the selected duration from the set of candidate mask elements so that it will not be masked.

FIG. 23 illustrates an example of a manual masking page 2300 including video content where a duration of it is highlighted as a candidate mask element on the video progress bar 2306. In FIG. 23, a button 2310 is displayed when the online forum detects the replier's video duration selecting action that involves sliding the left handle 2302 to select the starting time of the duration and sliding the right handle 2304 to select the ending time of the duration. The button 2310 provides the replier with the ability to add the selected duration 2308 to the set of candidate mask elements so that it will be masked.

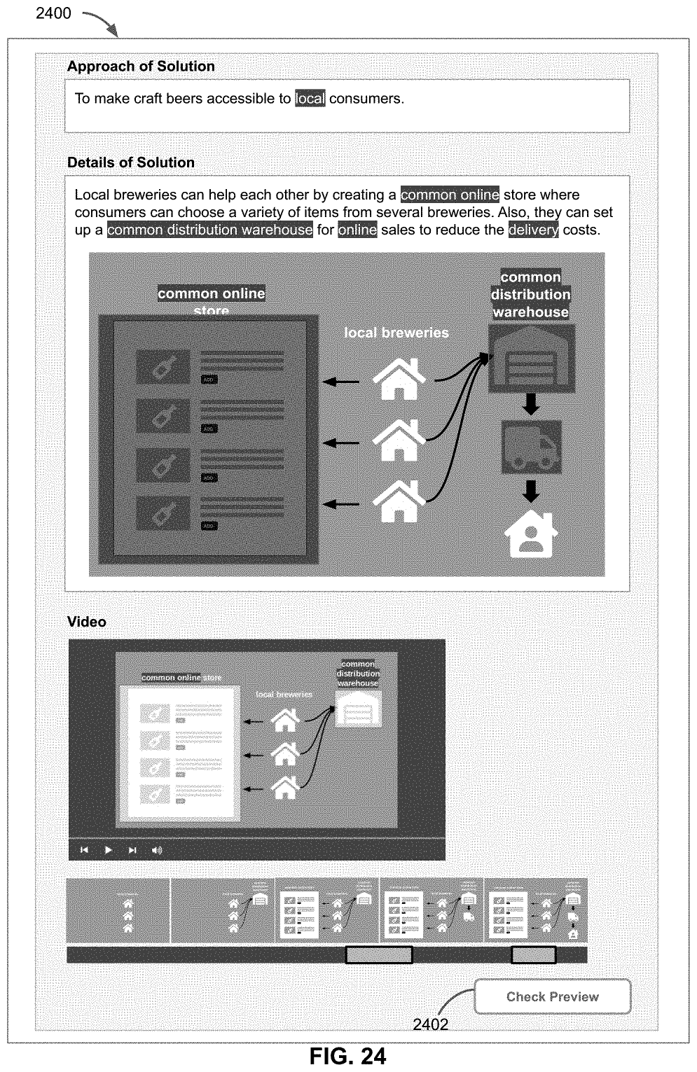

FIG. 24 illustrates an example of a manual masking page 2400 after the set of candidate mask elements are edited by the replier. When the preview button (or link) 2402 is clicked by the replier, the online forum guides the replier to a confirmation page.

FIG. 25 illustrates an example of a confirmation page 2500 which enables the replier to check whether the masked content hides the key concepts that lead information seekers to the understanding of the ideas or the knowledge while containing enough information to allow information seekers to determine whether the whole content is likely to include useful information that would be worth the rewards requested by the replier. In this example in FIG. 25, the replier can check the masking of the text content in solution approach 2504 and solution detail 2506 of the reply content 2502.

FIG. 26 illustrates an example of masked reply content 2600 in a confirmation page that includes a masked image 2602 and masked video content 2604. The replier can check the masking of these contents in addition to that of the text content.

Referring again to FIG. 25, the button 2508 with the text “Mask Automatically” is for requesting the online forum to dismiss all of the candidate mask elements presented in the confirmation page, then to determine candidate mask elements automatically, and then lastly, to lead the replier to the manual masking page where candidate mask elements that have been automatically detected are highlighted and the replier can edit the set of candidate mask elements.

The button 2510, with the text “Edit Masking”, is for requesting the online forum to lead the replier to the manual masking page again so that the replier can edit the set of candidate mask elements again.

The button 2512 with the text “Submit” is for requesting the online forum to post the masked reply content so that it will be displayed to other users.

FIG. 27 illustrates an example of a question page 2700 with masked reply content that has been posted by the replier. FIG. 27 shows one of the reward requests (1,000 idea coins) 2702 has been already fulfilled by the viewer of this page (e.g., USER B). In this example, a pop-up window 2706 is displayed because the “reward” button (or link) 2704 that is associated with one of the reward requests has been selected. The pop-up window 2706 provides the viewer with the ability to confirm his fulfillment of the reward (that is, in this case, the viewer's email address to be shared with the replier). A button (or link) 2708 with the text “Notify your interest in investment” provides the viewer with the ability to request the online forum to notify the replier that he is interested in investment relating to the idea presented in the reply content. The notification may appear in the “notification page” where the replier can read messages when he is logged into the online forum, or it may be sent to the replier by email although the means of notification are not limited to these. When all rewards are fulfilled, the online forum displays the unmasked (or original) reply content to the viewer (e.g., USER B) without its elements being masked.

FIG. 28 illustrates an example of a question page 2800 where the unmasked (original) reply content is displayed because all of its reward requests have been fulfilled by a viewer of this page (e.g., USER B). The clickable images 2802 provide the viewer with the ability to vote to express his level of satisfaction with the reply content. The text input box 2804 provides the viewer with the ability to post a comment to the reply content.

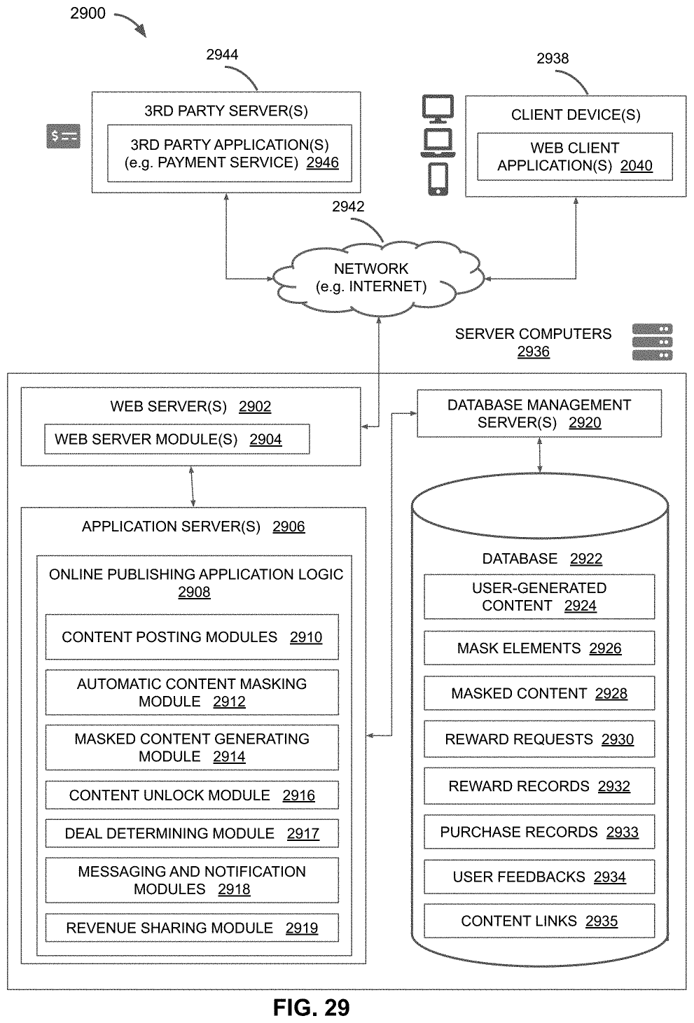

FIG. 29 is a block diagram illustrating various components or functional modules of an online publishing platform 2900, consistent with some embodiments of the invention. The online publishing platform 2900 has the same components or functional modules of the online forum 100 while its user-generated content 2924 has a different database table structure. Also, the online publishing platform 2900 stores additional “content links” 2935 which are hyperlinks between pieces of content in the online publishing platform 2900.

In FIG. 29, online publishing platform 2900 is implemented as a client-server model system. However, it is not limited to a client-server model system but it may be implemented as decentralized applications (Dapps).

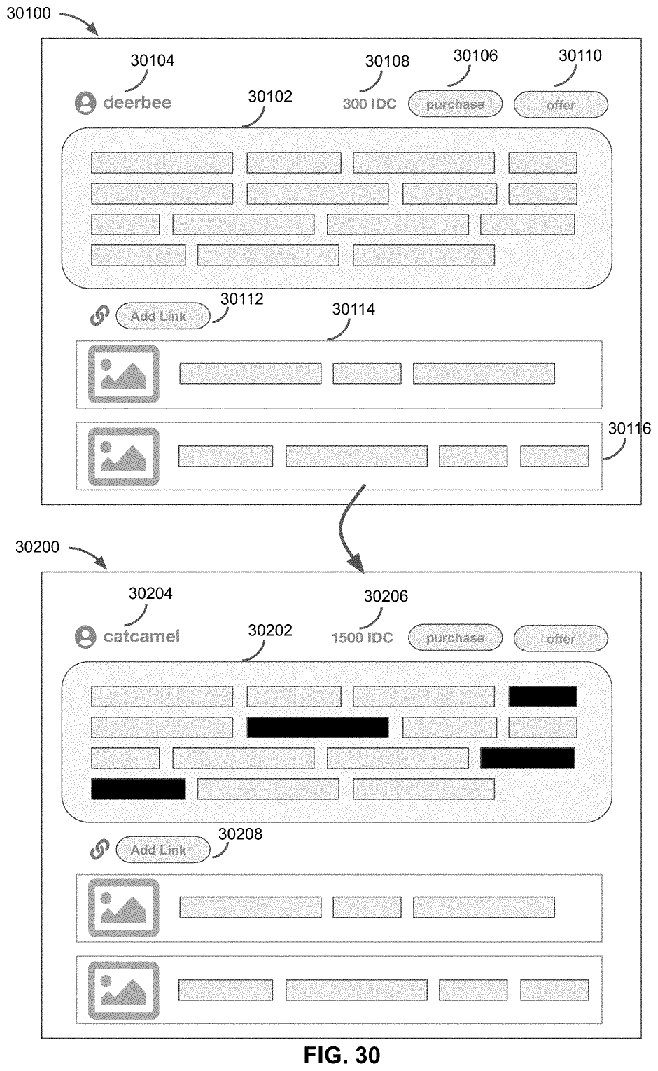

FIG. 30 shows a diagrammatic representation of the association between a content page 30100 and another content page 30200 on an example online publishing platform. In FIG. 30, a piece of “referring content” 30102 (“referring content” means content referring to another content via a link) is posted by user 30104. The referring content has two content links 30114 and 30116 that are clickable text areas where 30116 refers a user to content page 30200 when he clicks it.

In this example online publishing platform, a content link may be generated from the webform which appears when a user clicks the button 30112 or the button 30208. A content link may be generated by any user including the user who posted the referring content and the user who posted the referred content.

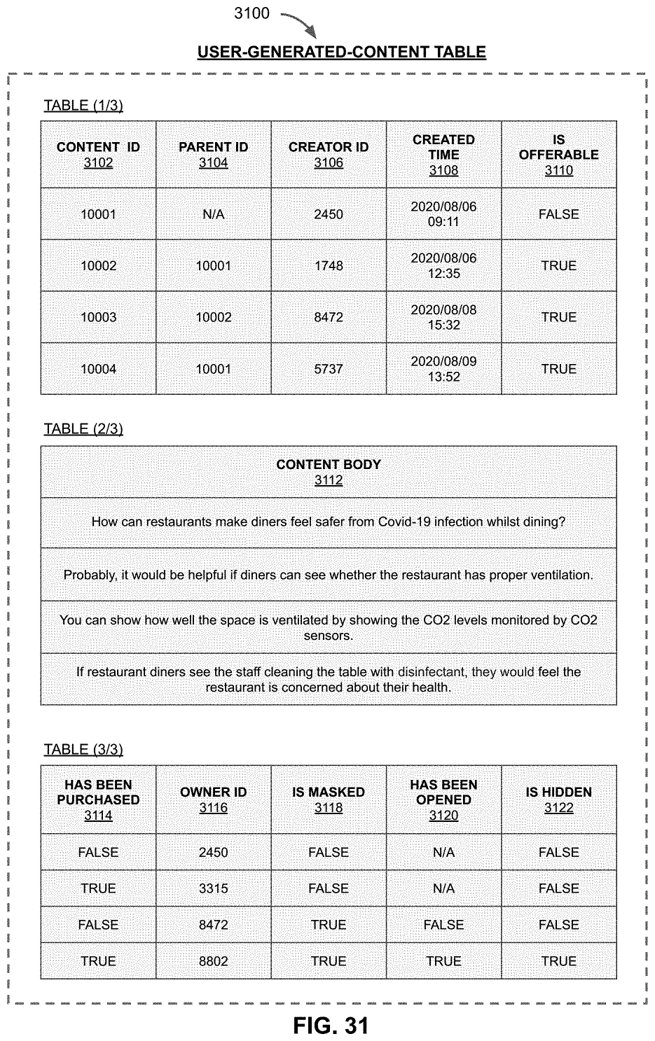

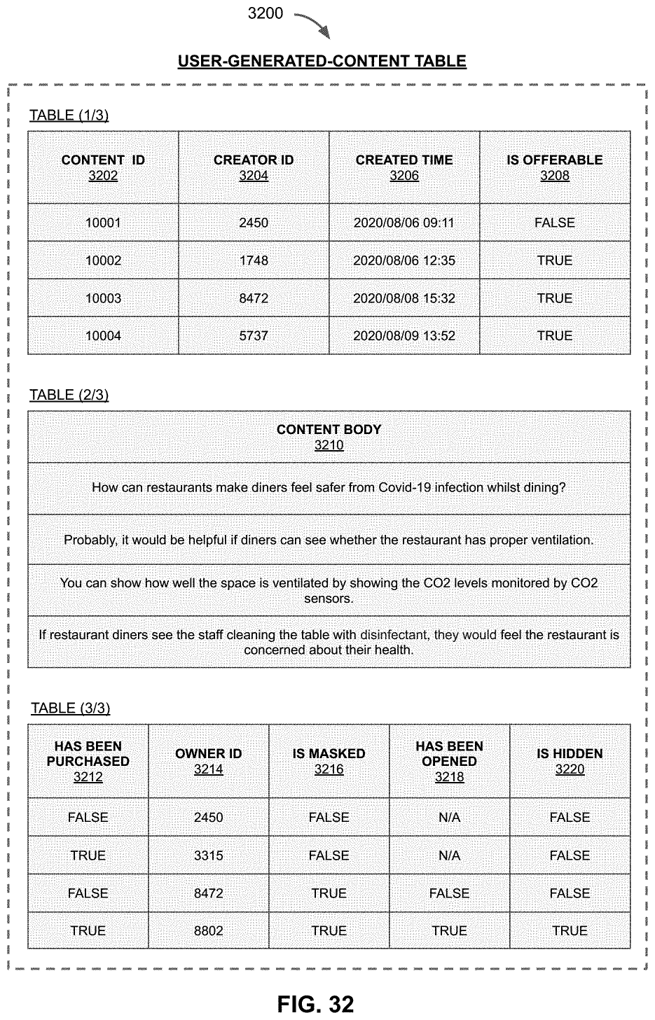

An example of a user-generated-content table 3100 for online forums is shown in FIG. 31. An example of a-user-generated-content table 3200 for online publishing platforms is shown in FIG. 32. In the example 3100, each piece of content is specified with content id 3102, parent id 3104 identifying which piece of content the content is replying to, creator id 3106 identifying the creator of the content, created time 3108 identifying the time when the content is created, “is offerable” 3110 identifying whether the option to make an offer to purchase the content has been made available to users other than the owner of the content, content body 3112, “has been purchased” 3114 identifying whether the content is purchased by a user other than the creator, owner id 3116 identifying the user who owns the content, “is masked” 3118 identifying whether parts of the content are masked, “has been opened” 3120 identifying whether the content has been disclosed to a user other than the creator in the case that the content is masked, and “is hidden” 3122 identifying whether the content is hidden from users other than the owner of it. In the descriptions regarding the invention, the “owner” of a piece of content represents a user who is specified by the systems by an identifier such as owner id 3116 that is associated with the piece of content.

In the example 3200, each piece of content is specified with the same fields as is the case in example 3100 except they do not have parent id since, on online publishing platforms, each piece of content is not connected to other pieces of content in a thread as is the case on online forums. However, on online publishing platforms, each piece of content may be associated with others via content links as shown in FIG. 30.

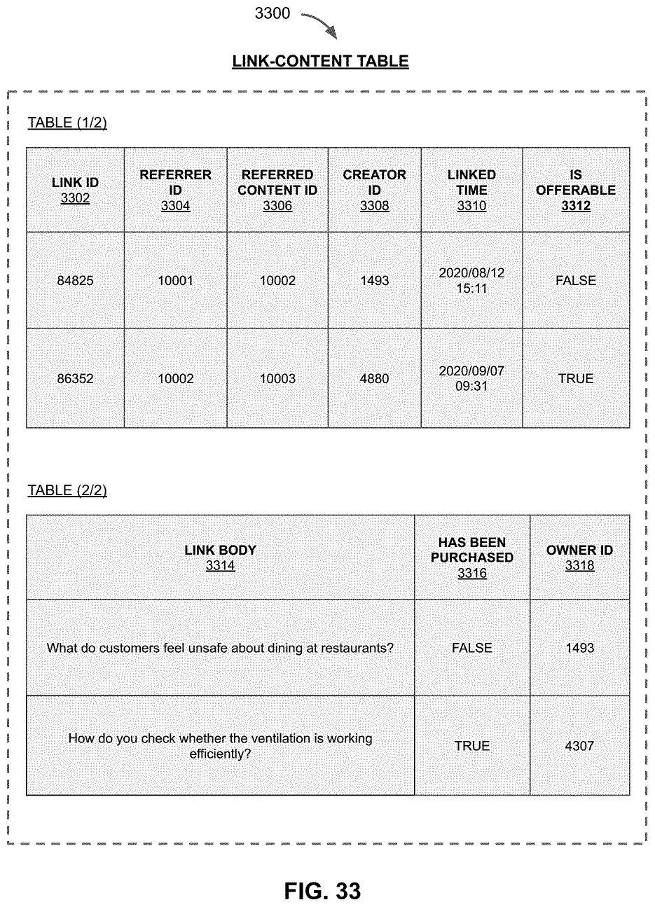

An example of content link table 3300 is shown in FIG. 33. In this example, each content link is specified with link id 3302, referrer id 3304 identifying the referring content, referred content id 3306 identifying the referred content, creator id 3308 identifying the creator of the content link, linked time 3310 identifying the time the content link is created, “is offerable” 3312 identifying whether the option to make an offer to purchase the link has been made available to users other than the owner of the link, link body 3314 which shows a description which motivates viewers of the referring content to see the referred content by clicking the link, “has been purchased” 3316, identifying whether the content has been purchased by a user other than the creator, and owner id 3318 identifying the owner of the content link.

In the previous descriptions, a “reward-on-disclosure” method in conjunction with “selective-information-revealing” was presented as a method to reward an information holder efficiently in the case that some parts of the information are particularly more important than other parts. However, even with the “selective-information-revealing”, a reward-on-disclosure method is not always suitable for the needs of information holders. For example, with a reward-on-disclosure method, an information holder might need to wait much longer than he wishes to receive the desired amount of reward; or the information he holds might be valuable only when disclosed to a limited number of people whereas a reward-on-disclosure method is a method to disclose information to an unspecified number of people. Hence, for the success of online platform applications or services (e.g., online forums, online publishing platforms) it is ideal to have wider options for rewarding an information holder to meet a wider set of needs that the information holder might have.

Therefore, to supply the wider rewarding opportunities to meet such needs, in some embodiments, the systems including, but not limited to, online forums and online publishing platforms may supply users with the facility to sell or purchase the privilege of the capabilities (e.g., to amend the piece of content) that the systems exclusively supply to the owner of a piece of content.

One advantage of this “sell-privilege” method is that the owner of a piece of masked content might be able to receive a certain amount of reward much sooner than he would if he were only receiving reward each time another user pays to see the whole of a piece of content on its disclosure. Another advantage of this feature is that he might be able to earn much more from his masked content than in the case of disclosing it to a plurality of users in cases where the content is valuable if the rarity of it is maintained. For example, if the technical know-how in a piece of content can bring an advantageous competitiveness to a company when it is known to only the company, the company might pay a much higher amount to the owner of the content than the sum of the rewards its owner would receive when it is disclosed to a plurality of users.

The capabilities that are exclusively supplied to the owner of a piece of content by the systems may be, but are not limited to:
Managing the content (e.g., updating the content, updating the set of mask elements, updating the reward requests, disclosing the content to himself, and hiding the content from other users)
Receiving the rewards the owner wishes in exchange for disclosing the whole content in the case of the piece of content being masked

The systems can supply exclusive capabilities regarding a piece of content to its owner by providing specific user interface elements to him only, consistent with embodiments of the invention. The examples of the user interface elements, the owner's actions, and the responses of the system are described below without the embodiments of the invention being limited to these examples.

Updating the Content

User Interface:
A webform for updating the existing content
A button for submission

Owner's Action(s):
Updating the content in the webform and clicking the button for submission

System Response(s):
Updating the body of the content in the database (e.g., content body 3112 in FIG. 31 in the case of online forums, content body 3210 in FIG. 32 in the case of online publishing platforms, and link body 3314 in FIG. 33 in the case of the content being a link)

Updating the Set of Mask Elements

User Interface:
A manual masking page that is described in connection with FIGS. 18 through 24

Owner's Action(s):
Updating the set of mask elements of the content including adding new mask elements, deleting existing mask elements, and changing the ranges or areas of existing mask elements on the manual masking page
Checking the new masked content created by the system and confirming it or otherwise updating the set of mask elements again

System Response(s):
Generating a piece of new masked content with masked content generating module 114 in FIG. 1 or 2914 in FIG. 29 according to the updated set of mask elements and storing it in the database
Presenting the confirmation page which shows the new masked content
Updating the set of mask elements in the database if the owner confirms, otherwise presenting the manual masking page again

Updating the Reward Requests

User Interface:
A button for adding a new reward request
A selectable drop-down list which appears when the add button is clicked enabling a user to specify a type of reward (e.g., legal currency such as USD, EURO or GBP, and tokens issued by the system) along with a numerical value input box enabling the user to specify the amount of reward
Buttons for deleting each existing reward request and pop-up confirmation windows which appear when the owner clicks the delete buttons

Owner's Action(s):
Updating the set of reward requests associated with the content including adding new reward requests and deleting existing requests

System Response(s):
Updating in the database, according to the owner's actions, the set of reward requests associated with the content

Disclosing the Content to Himself

In some embodiments of the invention, the purchaser of a piece of content that is masked by the previous owner or the creator may be able to view the unmasked (or original) content of it as default. However, in other embodiments of the invention, the systems may give the purchaser (new owner) the option of either disclosing the original content to himself or not.

A scenario in which the new owner would disclose the original content to himself is when he wishes to view the content for his own benefit such as developing the knowledge delivered by the content for his own business. On the other hand, a scenario in which the new owner would not disclose the original content to himself is when he wishes to sell the privilege regarding the content to another user who seeks to know the knowledge exclusively (except for the creator of the content). In such a case, the new owner of the content may be able to sell the privilege regarding the content at a higher price if he does not disclose it to himself. The system can present to users seeking to purchase the content whether the content has been disclosed to any user other than the creator by:
(1) changing in the database the value of “has been opened” (3120 in FIG. 31 in the case of an online forum and 3218 in FIG. 32 in the case of an online publishing platform) to “TRUE” in the event that the content is disclosed to a user who is not the creator of it;
(2) referring to the value of “has been opened” from the database If the value is “TRUE” the system presents a message saying that the content has been disclosed, and if the value is “FALSE” it presents a message saying that the content has not been disclosed along with the piece of content in the page where it is presented.

In the following, an example of user interface elements, owner's actions, and the responses of the system is described when the owner discloses the content to himself.

User Interface Elements:
A button that enables the owner to view the unmasked (original) content
A pop-up confirmation window that appears when the owner clicks the button

Owner's Action(s):
Clicking the button for viewing the unmasked (original) content and confirming with the pop-up confirmation window

System Response(s):
Changing the value of “has been opened” of the content to “TRUE” in the database and presenting the unmasked (original) content on a page that is accessible only to the owner when he or she logs in to the system.

Hiding the Content from Other Users

In some embodiments of the invention, the systems may provide owners of content with the ability to hide their content (including masked content) from other users in a scenario such as a purchaser (new owner) of a piece of content wishing to exclusively have the knowledge contained therein. In the following, an example of user interface elements, owner's actions, and the responses of the system are described when the owner hides the content from other users.

User Interface Elements:
A toggle switch with which the owner can choose whether to hide the content or not

Owner's Action(s):
Selecting to hide with the toggle switch

System Response(s):
Changing the value of “is hidden” (3122 in FIG. 31 in the case of online forums, and 3220 in FIG. 32 in the case of online publishing platforms) to “TRUE” in the database. The system uses this field to decide whether to show this content on events such as the system receiving from a user other than the owner an HTTP request to present the content, or the system recommending pieces of content to a user other than the owner. (If the value of the “is hidden” field is “TRUE”, the system will not show the content or include the content in content recommendations except to the owner)

FIG. 34 is a flow diagram representing a method for enabling the owner of a piece of content to sell to another user his privilege of the exclusive capabilities regarding a piece of content, consistent with embodiments of the invention.

As illustrated in FIG. 34, the method begins at method operation 3400 when a system presents a content-selling-configuration page associated with a piece of content to the owner, who can be specified by the owner id in the content table (e.g., 3116 in FIG. 31, 3214 in FIG. 32, 3318 in FIG. 33). For the purposes of this example, the owner of the piece of content is shown in FIG. 34 as “USER C”. In some embodiments of the invention, on the content-selling-configuration page, the system may provide the owner with the ability to specify whether to sell the privilege of the exclusive capabilities regarding the piece of content, to choose the methods of how to sell it, and to specify the conditions needed to be fulfilled so that deals via the selling methods are established.

The methods of selling may include, but are not limited to:
Offer by the owner: The owner of a piece of content specifies the type and amount of payment that he wishes and a deal is established when another user makes payment for it. In some embodiments of the invention, the system may provide the owner with the ability to specify more than one payment type and amount for each type, the system establishing a deal when all the requested payments are fulfilled.
Offer by users: Other users make offers with their desired amounts and payment types (e.g., legal currency such as USD, EURO, or GBP, and tokens issued by the system), and the system establishes a deal when the owner accepts an offer.

Auction: The owner opens an auction where other users may bid, the system establishing a deal when the winner of the auction is determined.

Some examples of user interface elements on the content-selling-configuration page that enable the owner to specify the methods of selling and the conditions to be fulfilled for a deal are the following:
A toggle switch with which the owner can choose whether to use the “Offer by the owner” method
A toggle switch with which the owner can choose whether to use the “Offer by users” method
A toggle switch with which the owner can choose whether to use the “Auction” method
Selectable drop-down lists which appear when “Offer by the owner” method or “Auction” is turned on by the owner enabling the owner to specify payment type (e.g., legal currency such as USD, EURO, or GBP, and tokens issued by the system).
A numerical value input box which appears when the “Offer by the owner” method is turned on by the owner, enabling the owner to specify the desired amount
A numerical value input box which appears when the “Auction” method is turned on by the owner enabling the owner to specify the lowest amount at which he is willing to sell the privilege regarding the content
Date picker UI element(s) and time picker UI element(s) which appear when the “Auction” method is turned on by the owner enabling the owner to specify the start date and time and the end date and time of the auction

Examples of the owner's interactions with the user interface elements are the following:
Turning on one or more toggle switches
If “Offer by the owner” is turned on, selecting the payment type with the selectable drop-down list, and inputting with the numerical value input box the amount he requests in exchange for transferring the privilege of the exclusive capabilities regarding the piece of the content
If “Auction” is turned on, selecting with the selectable drop-down list the desired payment type and inputting with the numerical value input box the lowest amount at which he is willing to sell the privilege regarding the piece of the content, and specifying with the date picker UI element(s) and time picker UI element(s) the start date and time and the end date and time of the auction

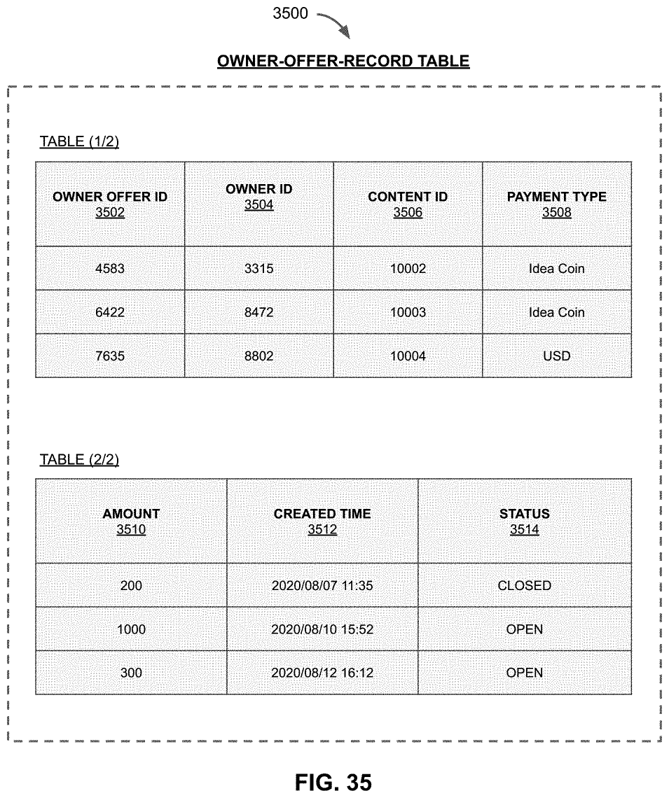

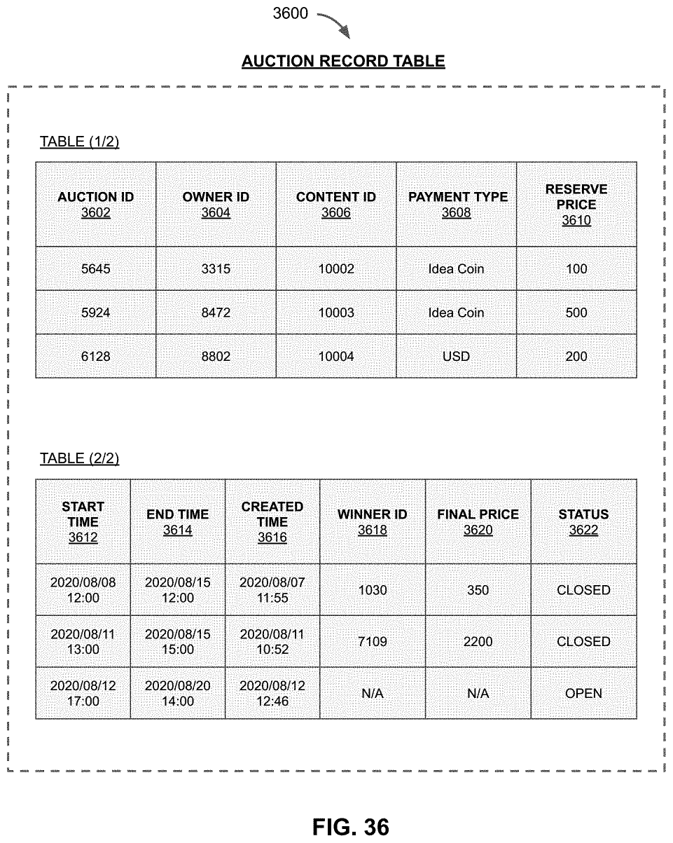

Examples of the system's responses to the owner's interactions with the above user interface elements are the following:
In the case of “Offer by the owner”: Adding a new owner-offer-record in the database according to the owner's interactions. An example of owner-offer-record table 3500 is shown in FIG. 35 where each record is specified with owner-offer id 3502, owner id 3504 identifying the owner of the content who made the offer, content id 3506 identifying the content that is on offer, payment type 3508 identifying the requested payment type for the content on offer, amount 3510 identifying the requested amount of payment, created time 3512 identifying the time when the record is created, and status 3514 identifying whether the offer is open or closed.
In the case of “Offer by users”: Changing the value of “is offerable”, associated with the piece of content (e.g. 3110 in FIG. 31, 3208 in FIG. 32, 3312 in FIG. 33) to “TRUE” in the database
In the case of “Auction”: Adding a new auction record in the database according to the owner's interactions. An example of auction record table 3600 is shown in FIG. 36 where each record is specified with auction id 3602, owner id 3604 identifying the owner of the content who opened the auction, content id 3606 identifying the content that is on auction, payment type 3608 identifying the requested payment type for the content on auction, reserve price 3610 identifying the lowest amount of the requested payment type at which the owner is willing to sell the privilege regarding the content, start time 3612 identifying the starting time of the auction, end time 3614 identifying the ending time of the auction, created time 3616 identifying the time when the record is created, winner id 3618 identifying the user who won the auction, final price 3620 identifying the price which the winner must pay for receiving the privilege of the exclusive capabilities regarding the content, and status 3622 identifying whether the auction is yet to start, open, or closed.

The owner can choose to sell the privilege of the exclusive capabilities regarding the content by selecting at least one of the selling methods provided by the system, or he can choose not to sell by keeping all of the selling methods unselected.

Returning to FIG. 34, at method operation 3402, the system accepts the owner's configuration(s) activating at least one of the selling methods.

In accordance with the activated selling methods, at method operation 3404, when a user requests the system to present the content, the system presents user interface element(s) that enable the user to purchase the privilege of the exclusive capabilities regarding the content. For the purposes of this example, the user is shown in FIG. 34 as “USER D”. Examples of processes for identifying whether each selling method is activated and examples of the user interface element(s) associated with each activated selling method are described as follows:

In the case of “Offer by the owner”

The process of identifying whether the method is activated:
The system queries the owner-offer-table (3500 in FIG. 35) in the database for records of “offer by the owner” whose content id (3506 in FIG. 35) refers to the piece of content and whose status (3514 in FIG. 35) is “open”. If such a record exists, the system presents UI elements for purchasing the privilege regarding the content.

UI element(s) to present if the method is activated:
A text area to show the price requested by the owner and a button enabling a user to pay it. Examples of the user interface elements are shown in FIG. 30 where the button 30106 with the text “purchase” is for paying the price requested by the owner and text area 30108 (“300 IDC”) is showing the requested amount of system-issued tokens. Also, the system may present a pop-up confirmation window before the purchase is placed to enable the user to confirm his payment.

In the case of “Offer by users”

The process of identifying whether the method is activated:
The system refers to the value of the “is offerable” field (e,g., 3110 in FIG. 31, 3208 in FIG. 32, 3312 in FIG. 33) of the piece of content in the database and presents UI elements if it is “TRUE”.

UI element(s) to present if the method is activated:
A button enabling a user to make an offer to purchase the content along with a selectable drop-down list where he can choose the payment type he wishes to use (e.g. system-issued tokens) and a numerical value input box enabling him to specify the amount of the payment type. Also, the system may present a pop-up confirmation window before the offer is placed to enable the user to confirm his offer. In FIG. 30, an example of a button with the text “offer” is shown 30110 with which a user may make an offer.

In the case of “Auction”

The process of identifying whether the method is activated:
The system queries the auction record table (3600 in FIG. 36) in the database for records of auction whose content id (3606 in FIG. 36) refers to the piece of content and whose status (3622 in FIG. 36) is “open”. If such a record exists, the system presents UI elements for placing a bid in the auction.

UI element(s) to present if the method is activated:
A button which enables a user to make the system present a pop-up window containing the information regarding the auction (e.g., reserve price, highest price that has been bid, starting and ending time), and a numerical value input box enabling him to specify his or her bid along with a button to submit it. In addition, the system may present a pop-up confirmation window before the bid is placed to enable the user to confirm his or her bid. After the bid is made, the system registers it to the database so that the bid can be referred to by the system after the auction ends so that the system can determine the winner of the auction.

At method operation 3406, the system detects the user's interactions with the user interface elements for purchasing the privilege of the exclusive capabilities regarding the content.

At method operation 3408, with the deal determining module (e.g., 117 in FIG. 1, 2917 in FIG. 29), the system determines whether a deal regarding the piece of content is established. The deal determining module is triggered when certain events happen on the system. Examples of the events that trigger the deal determining module and the processes of the module in response to each event are described below:

In the case of “Offer by the owner”:

In the event of the system detecting a user's interactions with the above described user interface elements in order to pay the price requested by the owner, the module determines the deal to be established.

In the case of “Offer by users”:

In the event of the system detecting offer making action(s) by a user with the user interface elements described above, the module notifies the owner of the content (via any messaging mechanisms such as email, SMS, or by showing it on a web page displayed) then determines that a deal is established if the owner accepts the offer (by interacting with user interface elements presented by the system such as a button for accepting the offer and a pop-up confirmation window to confirm the acceptance).

In the case of “Auction”:

In the event of an auction associated with the content ending at its scheduled end time (e.g., 3614 in FIG. 36), the module searches, in the database, the records of bids for the auction (that are created when users make bids), then determines that a deal is established if the highest bid is greater than the reserve price set by the owner as recorded in the reserve price field in the auction record table (e.g., 3610 in FIG. 36).

When a deal is established, at method operation 3410, the system transfers the price from the purchaser to the seller of the content. If the payment type is the system-issued token, the system creates a database transaction to deduct the amount of the deal from the purchaser's token balance and add the same amount to the seller's token balance. If the payment type is not the system-issued token, but another type such as legal currency (e.g., USD, EURO, or GBP), the system first accepts the payment of the purchaser, then sends the payment to the seller interacting with any related third-party (or proprietary) modules (e.g., a third-party payment service). In some embodiments of the invention, the system may deduct a transaction fee from the purchaser's payment before it is sent to the seller of the content.

After the price is transferred to the seller, at method operation 3412, the system transfers the privilege of the exclusive capabilities regarding the content. This transfer is executed by changing the owner of the content from the seller to the purchaser by changing the value of the owner id of the content (e.g., 3116 in FIG. 31, 3214 in FIG. 32, 3318 in FIG. 33) to refer to the purchaser (i.e., changing the value of the owner id to the value of the user id of the purchaser). Accordingly, the system supplies to the new owner (the purchaser) alone the certain user interface elements, examples of which are described above, so that he can have the privilege of the exclusive capabilities regarding the content.

In some embodiments of the invention, the execution of method operation 3412 may precede the execution of method operation 3410.

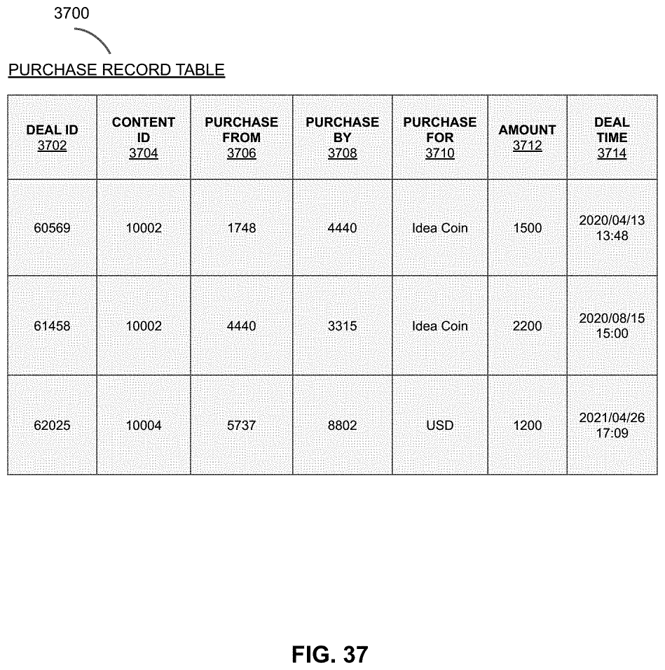

After the owner of the content is changed, at method operation 3414, the system stores the record of the purchase in the database. An example of a purchase record table is shown at 3700 in FIG. 37. In this example, each purchase record is specified with deal id 3702, content id 3704 identifying the piece of content that has been purchased, “purchase from” 3706 identifying the previous owner, “purchase by” 3708 identifying the new owner, “purchase for” 3710 identifying the type of payment of the deal, amount 3712 identifying the amount of the payment type, and deal time 3714 identifying the time that the deal is created.

Finally, at method operation 3416, the system notifies the seller (previous owner) and the purchaser (new owner) of the completion of the deal via any messaging mechanisms such as email, SMS, or by showing messages on web pages displayed to them.

In the previous descriptions, a “sell-privilege” method was presented to meet a wider set of needs of an information holder to earn from his information. In the following, another method, “share-revenue”, will be described to meet another potential need of an information holder when he wishes to earn from his “beneficial but poorly-rewarded” content. An example of such content is educational content which explains well publicly available knowledge but may not bring reward in accordance with its merits to viewers because of its lack of uniqueness, rarity, inspiration, or novelty. However, for the usefulness of applications or services (e.g., online forums, online publishing platforms), it is important to motivate users to post such “beneficial but poorly-rewarded” content. The aim of the share-revenue method is that the owners of such content are rewarded according to the contributions that their content brings to the generation of other users' revenues. However, the benefit of the “share-revenue” method is not limited to owners of such content.

Therefore, in some embodiments, the systems, including (but not limited to) online forums and online publishing platforms, may share a portion of the revenue received by an owner of content for disclosing his or her masked content or selling his or her privilege regarding the content with users who contributed to the generation of the revenue. Users who benefit from the “share-revenue” method are not limited to owners of masked content but include owners of content which is not masked and owners of content links (e.g., 30114 and 30116 in FIG. 30). Therefore, the share-revenue method encourages users to post user-generated content and to add links between pieces of content on systems such as online publishing platforms.

In the following descriptions, the term “trade” includes both disclosing/viewing a piece of masked content without its elements being masked for rewards, and selling/purchasing the privilege of the exclusive capabilities regarding a piece of content for a payment. The term “payer” represents the user who pays the requested reward to view a piece of masked content without its elements being masked or purchases the privilege regarding a piece of content.

By way of example and not limitation, users' contributions to the generation of other users' revenues are described below.

On an online forum, the owner (and the creator) of a parent (or any ancestor) content of the traded content contributed to the trade as they led the payer to the traded content. In the description of the invention, the expression “parent content of content-A” represents a piece of content to which content-A replies in an online forum.

On an online publishing platform, the owner (and also the creator) of a link via which the payer reached the content which was subsequently traded contributed to the trade as it was his link that led the payer to the content; also, the owner (and the creator) of a referring content from which the payer was referred to the traded content (via a link) contributed to the trade as it was his content that led the payer to the traded content. Furthermore, the owner of any content or any link that is in the path through which the payer was led to the traded content may also be one of the contributors. For the system to be able to recognize the path of the payer that led him or her to the traded content, it may store the record of each user's selection of links (e.g., in the database). For example, if a user selected two links where the first link's “link id” is “84825” and the second link's “link id” is “86352” as in the case of FIG. 33, the system can determine that he or she first visited the content whose id is “10001”, then visited the content whose id is “10002” secondly before visiting the content whose id is “10003”.

In some embodiments of the invention, a system may include, in the group of parties among which revenue is to be shared, all of the contributors to a trade or some of the contributors. Also, in some embodiments of the invention, the system may include itself as one of the parties of a revenue sharing in order to deduct transaction fees.

FIG. 38 is pseudocode of an example algorithm for a revenue sharing in an online forum where revenue for a piece of traded content is shared with the owners of its parent or ancestor content in a forum thread and payment for the traded content is by system issued tokens (the amount being deducted from the payer's token balance). In the pseudocode, the example algorithm for the revenue sharing is implemented as a recursive function that determines the amount of system-issued tokens to share to each party and executes the payment by recursively traversing the content tree starting from the traded content in the forum thread. In the following description, the term “object” used in conjunction with pieces of pseudocode in FIG. 38 and FIG. 39, represents an instance of a class in object-oriented programming.

In line 1, in the pseudocode, the constant value which specifies the share of each party is set. In this pseudocode, “RATE_TO_PARENT=0.1” represents that, as the content tree is traversed, the owner of a piece of content receives 10 percent of the revenue received by the owner of its child content.

In line 3, the recursive function revenue_share receives “CONTENT” which is an object that includes information regarding a piece of content (e.g., content id, parent id, etc. in FIG. 31) retrieved from the database and “REWARD_AMOUNT” which is the amount of system-issued tokens paid to the owner of the piece of content from which the “CONTENT” object originates. Particularly, when the function is initially called, “CONTENT” is an object which is originated from the traded content and “REWARD_AMOUNT” is the amount of system-issued tokens that is paid from the payer to the owner of the traded content.

In line 5, it is determined whether the content from which the “CONTENT” object originates has parent content (it has if the value of its “parent id” is not empty or null in the user-generated-content table). If the content has parent content, in line 7, the payment to the owner of the parent content (“REWARD_TO_PARENT”) is determined by referring to “RATE_TO_PARENT” and the payment to the owner of the content (“REWARD_TO_CONTENT”) is determined in line 8. Also, in line 9, “REWARD_TO_CONTENT” is paid to the owner of the content (“REWARD_TO_CONTENT” is added to his token balance). Then, if “REWARD_TO_PARENT” is not zero, in line 12, the function revenue_share is recursively called receiving the object originated from the parent content and “REWARD_TO_PARENT” as its arguments. (The object of the parent content can be generated with the information retrieved from the user-generated-content table in the database by referring to the parent id in the “CONTENT” object). If the content does not have parent content in line 5, “REWARD_AMOUNT” is added to the token balance of the owner of the content from which the “CONTENT” object originates in line 16.

FIG. 39 is pseudocode of an example algorithm for a revenue sharing in an online publishing platform where revenue from a piece of traded content is shared with the owners of the pieces of content and of content links in the pathway through which the payer was led to the traded content and with the creator of the traded content; payment for the traded content being by system issued tokens (the amount being deducted from the payer's token balance).

In the pseudocode, the example algorithm for the revenue sharing is implemented as a recursive function that determines the amount of system-issued tokens to share to each party and executes the payment by recursively traversing the path through which the payer was led to the traded content starting from the traded content.

In lines 1, 2, and 3, in the pseudocode, the constant values which specify the share of each party are set. In this pseudocode, “RATE_TO_REFERRER=0.06” represents that, as the path is traversed, the owner of a piece of content receives 6 percent of the revenue received by the owners of the previous content and the previous link-content in the path. Also “RATE_TO_LINK=0.04” represents that, as the path is traversed, the owner of a piece of link-content receives 4 percent of the revenue received by the owners of the previous content and the previous link-content in the path. “RATE_TO_CREATOR=0.1” represents that the owner of the traded content shares 10 percent of his revenue with the creator of the traded content.

In line 5, the recursive function revenue_share receives “CONTENT” which is an object that includes information regarding a piece of content (including link-content) (e.g., content id 3202, creator id 3204 etc in FIG. 32, or link id 3302, referrer id 3304 etc. in FIG. 33) retrieved from the database, and “REWARD_AMOUNT” which is the amount of system-issued tokens paid to the owner of the piece of content from which the “CONTENT” object originates, and “creator_paid” that is a Boolean regarding whether the creator of the traded content has already been paid.

Particularly, when the function is called initially, “CONTENT” is an object which is originated from the traded content, “REWARD_AMOUNT” is the amount of system-issued tokens that is paid from the payer to the owner of the traded content, and “creator_paid” is “False”.

In line 7, it is determined whether the content from which the “CONTENT” object originates is referred to by another content in the path. If such referring content exists, in line 9, the payment to the owner of the referring content (“REWARD_TO_REFERRER”) is determined by using the value of “RATE_TO_REFERRER” and the payment to the owner of the link via which the referring content refers to the referred content (“REWARD_TO_LINK”) is determined by using the value of “RATE_TO_LINK” in line 10.

In line 12, it is determined whether the creator of the traded content is already paid. If he or she has not been paid yet, in line 13, the payment to him or her (“REWARD_TO_CREATOR”) is determined by referring to “RATE_TO_CREATOR”, and the payment to the owner of the content (“REWARD_TO_CONTENT”) is determined in lines 14 and 15 by deducting the payments to three parties (“REWARD_TO_REFERRER”, “REWARD_TO_LINK”, and “REWARD_TO_CREATOR”) from “REWARD_AMOUNT”. Then, in line 16, “REWARD_TO_CREATOR” is paid to the creator of the traded content (“REWARD_TO_CREATOR” is added to his token balance). Then, in line 17, “creator_paid” is set to “True” to ensure that the creator of the traded content is paid only one time.

If the creator of the traded content has been paid already in line 12, the payment to the owner of the content (“REWARD_TO_CONTENT”) is determined in lines 20 and 21 by deducting the payments to two parties (“REWARD_TO_REFERRER” and “REWARD_TO_LINK”) from “REWARD_AMOUNT”.

Also, In line 24, “REWARD_TO_CONTENT” is paid to the owner of the content or link-content (“REWARD_TO_CONTENT” is added to his token balance). Then, if “REWARD_TO_REFERRER” is not zero, in line 27, the function revenue_share is recursively called receiving the object regarding the referring content, “REWARD_TO_REFERRER” and “creator_paid” as its arguments. —Likewise, if “REWARD_TO_LINK” is not zero, in line 31, the function revenue_share is recursively called receiving the object of the link-content, “REWARD_TO_LINK” and “creator_paid” as its arguments. The link can be identified by referring to the stored record (e.g., in the database) of the link selection by the payer. (The recording of the link selection of users was described previously in connection with a method for recognizing the path through which the payer was led to the traded content.)

If the content from which the “CONTENT” object originates does not have referring content in line 7, it is determined whether the creator of the traded content has already been paid in line 35. If he or she has not been paid yet, in line 36, the payment to him or her (“REWARD_TO_CREATOR”) is determined by referring to “RATE_TO_CREATOR”, and the payment to the owner of the content (“REWARD_TO_CONTENT”) is determined in line 37 by deducting the payment to the creator of the traded content (“REWARD_TO_CREATOR”) from “REWARD_AMOUNT”. Then, in line 38, “REWARD_TO_CREATOR” is paid to the creator of the traded content (“REWARD_TO_CREATOR” is added to his or her token balance) and “REWARD_TO_CONTENT” is paid to the owner of the content (“REWARD_TO_CONTENT” is added to his or her token balance) in line 39.

If the creator of the traded content has been paid already in line 35, “REWARD_AMOUNT” is paid to the owner of the content from which the “CONTENT” object originates without any deductions for payment to other parties in line 41 (“REWARD_AMOUNT” is added to his token balance).

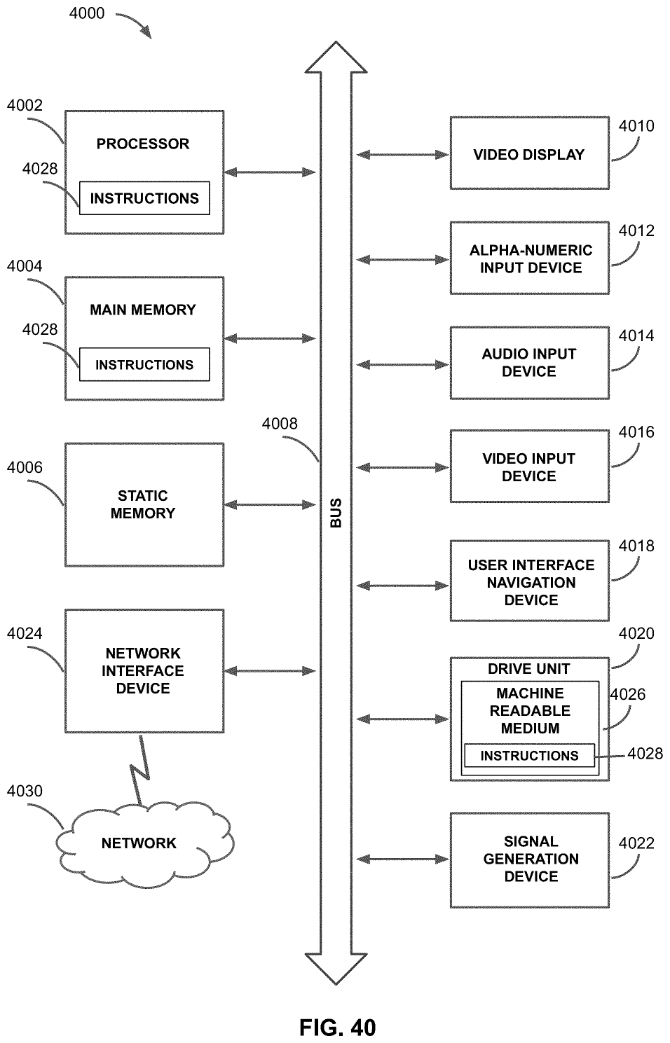

FIG. 40 is a block diagram illustrating components of a machine 4000, according to some example embodiments, able to read instructions from a machine-readable medium (e.g., a machine-readable storage medium) and perform any one or more of the methodologies discussed herein.

Specifically, the machine 4000 may implement the online forum 100 and the online publishing platform 2900 and the respective features included and described therein. The machine 4000 thus describes specific hardware configurations on which the online forum 100 and the online publishing platform 2900 may be implemented and provided to users of the online forum 100 and the online publishing platform 2900.

FIG. 40 shows a diagrammatic representation of the machine 4000 in the example form of a computer system and within which instructions 4028 (e.g., software) for causing the machine 4000 to perform any one or more of the methodologies discussed herein may be executed. In alternative embodiments, the machine 4000 operates as a standalone device or may be connected (e.g., networked) to other machines. In a networked deployment, the machine 4000 may operate in the capacity of a server machine or a client machine in a server-client network environment, or as a peer machine in a peer-to-peer (or distributed) network environment. The machine 4000 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 4028, sequentially or otherwise, that specify actions to be taken by that machine. Further, while only a single machine is illustrated, the term “machine” shall also be taken to include a collection of machines that individually or jointly execute the instructions 4028 to perform any one or more of the methodologies discussed herein.

The machine 4000 includes a processor 4002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 4004, and a static memory 4006, which are configured to communicate with each other via a bus 4008. The machine 4000 may further include a graphics display 4010 (e.g., a plasma display panel (PDP), a light emitting diode (LED) display, a liquid crystal display (LCD), a projector, or a cathode ray tube (CRT)). The machine 4000 may also include an alphanumeric input device 4012 (e.g., a keyboard), an audio input device 4014 (e.g., a microphone), a video input device 4016 (e.g., a video camera), a cursor control device 4018 (e.g., a mouse, a touchpad, a trackball, a joystick, a motion sensor, or other pointing instrument), a storage unit 4020, a signal generation device 4022 (e.g., a speaker), and a network interface device 4024.

The storage unit 4020 includes a machine-readable medium 4026 on which is stored the instructions 4028 (e.g., software) embodying any one or more of the methodologies or functions described herein. The instructions 4028 may also reside, completely or at least partially, within the main memory 4004, within the processor 4002 (e.g., within the processors cache memory), or both, during execution thereof by the machine 4000. Accordingly, the main memory 4004 and the processor 4002 may be considered as machine-readable media. The instructions 4028 may be transmitted or received over a network 4030 via the network interface device 4024.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 4026 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 4000), such that the instructions, when executed by one or more processors of the machine (e.g., processor 4002), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A computer-implemented method comprising:
receiving, from a first user, user-generated content;
receiving, from the first user, user input specifying one or more elements to be masked in the user-generated content;
receiving, from a second user, a request to present the user-generated content received from the first user;
in response to the request, presenting to the second user the user-generated content wherein the one or more elements to be masked associated with the user-generated content are masked;

2. The computer-implemented method of claim 1, further comprising:
determining, with a processor-implemented content masking module, candidates for one or more elements to be masked in the user-generated content received from the first user;
prior to the step of receiving user input specifying one or more elements to be masked, presenting to the first user the user-generated content wherein the presentation of the one or more candidate elements to be masked determined by the content masking module is differentiated from the presentation of the other elements in the user-generated content;

3. The computer-implemented method of claim 2, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

4. The computer-implemented method of claim 3, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

5. The computer-implemented method of claim 4, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

6. The computer-implemented method of claim 4, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

7. The computer-implemented method of claim 6, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

8. The computer-implemented method of claim 3, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

9. The computer-implemented method of claim 2, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

10. The computer-implemented method of claim 9, further comprising:
with a processor-implemented revenue sharing module, sharing the revenue between a plurality of users in the event that the privileged user regarding the user-generated content receives a price in exchange for transferring his privilege regarding the content;

11. The computer-implemented method of claim 9, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

12. The computer-implemented method of claim 11, further comprising:
with a processor-implemented revenue sharing module, sharing the revenue between a plurality of users in the event that the privileged user regarding the user-generated content receives a price in exchange for transferring his privilege regarding the content;

13. The computer-implemented method of claim 2, wherein the user-generated content comprises one or more of the group consisting of text, images, audios, and videos;

14. The computer-implemented method of claim 13, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

15. The computer-implemented method of claim 14, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

16. The computer-implemented method of claim 15, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

17. The computer-implemented method of claim 15, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

18. The computer-implemented method of claim 17, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

19. The computer-implemented method of claim 14, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

20. The computer-implemented method of claim 13, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

21. The computer-implemented method of claim 20, further comprising:
with a processor-implemented revenue sharing module, sharing the revenue between a plurality of users in the event that the privileged user regarding the user-generated content receives a price in exchange for transferring his privilege regarding the content;

22. The computer-implemented method of claim 20, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

23. The computer-implemented method of claim 22, further comprising:
with a processor-implemented revenue sharing module, sharing the revenue between a plurality of users in the event that the privileged user regarding the user-generated content receives a price in exchange for transferring his privilege regarding the content;

24. The computer-implemented method of claim 1, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

25. The computer-implemented method of claim 24, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

26. The computer-implemented method of claim 25, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

27. The computer-implemented method of claim 25, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

28. The computer-implemented method of claim 27, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

29. The computer-implemented method of claim 24, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

30. The computer-implemented method of claim 1, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

31. The computer-implemented method of claim 30, further comprising:
with a processor-implemented revenue sharing module, sharing the revenue between a plurality of users in the event that the privileged user regarding the user-generated content receives a price in exchange for transferring his privilege regarding the content;

32. The computer-implemented method of claim 30, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

33. The computer-implemented method of claim 32, further comprising:
with a processor-implemented revenue sharing module, sharing the revenue between a plurality of users in the event that the privileged user regarding the user-generated content receives a price in exchange for transferring his privilege regarding the content;

34. The computer-implemented method of claim 1, wherein the user-generated content comprises one or more of the group consisting of text, images, audios, and videos;

35. A computer-implemented method comprising:
receiving, from a first user, user-generated content;
determining, with a processor-implemented content masking module, one or more elements to be masked in the user-generated content received from the first user;
receiving, from a second user, a request to present the user-generated content received from the first user;
in response to the request, presenting to the second user the user-generated content wherein the one or more elements to be masked associated with the user-generated content are masked;

36. The computer-implemented method of claim 35, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

37. The computer-implemented method of claim 35, wherein the user-generated content comprises one or more of the group consisting of text, images, audios, and videos;

38. A non-transitory computer-readable medium storing executable instructions thereon, which, when executed by a processor, cause the processor to perform operations including:
receiving, from a first user, user-generated content;
receiving, from the first user, user input specifying one or more elements to be masked in the user-generated content;
receiving, from a second user, a request to present the user-generated content received from the first user;
in response to the request, presenting to the second user the user-generated content wherein the one or more elements to be masked associated with the user-generated content are masked;

39. The non-transitory computer-readable medium of claim 38, further comprising:
determining, with a processor-implemented content masking module, candidates for one or more elements to be masked in the user-generated content received from the first user;
prior to the step of receiving user input specifying one or more elements to be masked, presenting to the first user the user-generated content wherein the presentation of the one or more candidate elements to be masked determined by the content masking module is differentiated from the presentation of the other elements in the user-generated content;

40. The non-transitory computer-readable medium of claim 39, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

41. The non-transitory computer-readable medium of claim 40, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

42. The non-transitory computer-readable medium of claim 41, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

43. The non-transitory computer-readable medium of claim 41, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

44. The non-transitory computer-readable medium of claim 43, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

45. The non-transitory computer-readable medium of claim 40, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

46. The non-transitory computer-readable medium of claim 39, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

47. The non-transitory computer-readable medium of claim 46, further comprising:
with a processor-implemented revenue sharing module, sharing the revenue between a plurality of users in the event that the privileged user regarding the user-generated content receives a price in exchange for transferring his privilege regarding the content;

48. The non-transitory computer-readable medium of claim 46, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

49. The non-transitory computer-readable medium of claim 48, further comprising:
with a processor-implemented revenue sharing module, sharing the revenue between a plurality of users in the event that the privileged user regarding the user-generated content receives a price in exchange for transferring his privilege regarding the content;

50. The non-transitory computer-readable medium of claim 39, wherein the user-generated content comprises one or more of the group consisting of text, images, audios, and videos;

51. The non-transitory computer-readable medium of claim 50, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

52. The non-transitory computer-readable medium of claim 51, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

53. The non-transitory computer-readable medium of claim 52, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

54. The non-transitory computer-readable medium of claim 52, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

55. The non-transitory computer-readable medium of claim 54, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

56. The non-transitory computer-readable medium of claim 51, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

57. The non-transitory computer-readable medium of claim 50, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

58. The non-transitory computer-readable medium of claim 57, further comprising:
with a processor-implemented revenue sharing module, sharing the revenue between a plurality of users in the event that the privileged user regarding the user-generated content receives a price in exchange for transferring his privilege regarding the content;

59. The non-transitory computer-readable medium of claim 57, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

60. The non-transitory computer-readable medium of claim 59, further comprising:
with a processor-implemented revenue sharing module, sharing the revenue between a plurality of users in the event that the privileged user regarding the user-generated content receives a price in exchange for transferring his privilege regarding the content;

61. The non-transitory computer-readable medium of claim 38, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

62. The non-transitory computer-readable medium of claim 61, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

63. The non-transitory computer-readable medium of claim 62, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

64. The non-transitory computer-readable medium of claim 62, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

65. The non-transitory computer-readable medium of claim 64, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

66. The non-transitory computer-readable medium of claim 61, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

67. The non-transitory computer-readable medium of claim 38, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

68. The non-transitory computer-readable medium of claim 67, further comprising:
with a processor-implemented revenue sharing module, sharing the revenue between a plurality of users in the event that the privileged user regarding the user-generated content receives a price in exchange for transferring his privilege regarding the content;

69. The non-transitory computer-readable medium of claim 67, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

70. The non-transitory computer-readable medium of claim 69, further comprising:
with a processor-implemented revenue sharing module, sharing the revenue between a plurality of users in the event that the privileged user regarding the user-generated content receives a price in exchange for transferring his privilege regarding the content;

71. The non-transitory computer-readable medium of claim 38, wherein the user-generated content comprises one or more of the group consisting of text, images, audios, and videos;

72. A non-transitory computer-readable medium storing executable instructions thereon, which, when executed by a processor, cause the processor to perform operations including:
receiving, from a first user, user-generated content;
determining, with a processor-implemented content masking module, one or more elements to be masked in the user-generated content received from the first user;
receiving, from a second user, a request to present the user-generated content received from the first user;
in response to the request, presenting to the second user the user-generated content wherein the one or more elements to be masked associated with the user-generated content are masked;

73. The non-transitory computer-readable medium of claim 72, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

74. The non-transitory computer-readable medium of claim 72, wherein the user-generated content comprises one or more of the group consisting of text, images, audios, and videos;

75. A computer system, comprising:
a processor;
a memory device holding an instruction set executable on the processor to cause the computer system to perform operations comprising:
receiving, from a first user, user-generated content;
receiving, from the first user, user input specifying one or more elements to be masked in the user-generated content;
receiving, from a second user, a request to present the user-generated content received from the first user;
in response to the request, presenting to the second user the user-generated content wherein the one or more elements to be masked associated with the user-generated content are masked;

76. The computer system of claim 75, further comprising:
determining, with a processor-implemented content masking module, candidates for one or more elements to be masked in the user-generated content received from the first user;
prior to the step of receiving user input specifying one or more elements to be masked, presenting to the first user the user-generated content wherein the presentation of the one or more candidate elements to be masked determined by the content masking module is differentiated from the presentation of the other elements in the user-generated content;

77. The computer system of claim 76, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

78. The computer system of claim 77, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

79. The computer system of claim 78, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

80. The computer system of claim 78, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

81. The computer system of claim 80, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

82. The computer system of claim 77, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

83. The computer system of claim 76, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

84. The computer system of claim 83, further comprising:
with a processor-implemented revenue sharing module, sharing the revenue between a plurality of users in the event that the privileged user regarding the user-generated content receives a price in exchange for transferring his privilege regarding the content;

85. The computer system of claim 83, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

86. The computer system of claim 85, further comprising:
with a processor-implemented revenue sharing module, sharing the revenue between a plurality of users in the event that the privileged user regarding the user-generated content receives a price in exchange for transferring his privilege regarding the content;

87. The computer system of claim 76, wherein the user-generated content comprises one or more of the group consisting of text, images, audios, and videos;

88. The computer system of claim 87, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

89. The computer system of claim 88, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

90. The computer system of claim 89, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

91. The computer system of claim 89, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

92. The computer system of claim 91, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

93. The computer system of claim 88, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

94. The computer system of claim 87, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

95. The computer system of claim 94, further comprising:
with a processor-implemented revenue sharing module, sharing the revenue between a plurality of users in the event that the privileged user regarding the user-generated content receives a price in exchange for transferring his privilege regarding the content;

96. The computer system of claim 94, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

97. The computer system of claim 96, further comprising:
with a processor-implemented revenue sharing module, sharing the revenue between a plurality of users in the event that the privileged user regarding the user-generated content receives a price in exchange for transferring his privilege regarding the content;

98. The computer system of claim 75, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

99. The computer system of claim 98, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

100. The computer system of claim 99, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

101. The computer system of claim 99, wherein the exclusive capabilities regarding the user-generated content comprises one or more of the group consisting of:
i) updating the user-generated content;
ii) updating the one or more elements to be masked in the user-generated content;
iii) specifying the one or more requests for reward in exchange for disclosing the user-generated content without any of its elements being masked in the case of the user-generated content being masked;
iv) receiving the rewards in the event that one or more of the requests for reward are fulfilled by another user;
v) viewing the user-generated content without any of its elements being masked in the case of the user-generated content being masked;
vi) preventing the user-generated content from being presented to other users;

102. The computer system of claim 101, further comprising:
with a processor-implemented revenue sharing module, sharing the revenue between a plurality of users in the event that the privileged user regarding the user-generated content receives one or more requested rewards in exchange for disclosing the content without any of its elements being masked or receives a price in exchange for transferring his privilege regarding the content;

103. The computer system of claim 98, further comprising:
with a processor-implemented revenue sharing module, sharing the revenue between a plurality of users in the event that the privileged user who is privileged with one or more exclusive capabilities regarding the user-generated content, who is the first user in the case the privilege has not been transferred to another user, receives one or more requested rewards in exchange for disclosing the user-generated content without any of its elements being masked;

104. The computer system of claim 75, further comprising:
receiving, from the privileged user who is privileged with one or more exclusive capabilities regarding the user-generated content, who is the first user in the case the privilege has not been transferred to another user, user input specifying one or more selling methods and one or more conditions for establishing a deal via each of the one or more selling methods;
presenting, to a purchasing user, one or more user interface elements enabling him to make one or more interactions for purchasing the privilege via the one or more selling methods specified by the privileged user;
receiving, from the purchasing user, one or more interactions with the one or more user interface elements;
determining, with a processor-implemented deal determining module, whether a deal regarding the user-generated content is established;
in the case of a deal being established, transferring the price of the deal from the purchasing user to the privileged user and transferring the privilege from the privileged user to the purchasing user;

105. The computer system of claim 104, further comprising:
with a processor-implemented revenue sharing module, sharing the revenue between a plurality of users in the event that the privileged user regarding the user-generated content receives a price in exchange for transferring his privilege regarding the content;

106. The computer system of claim 104, wherein the exclusive capabilities regarding the user-generated content comprises one or more of the group consisting of:
i) updating the user-generated content;
ii) updating the one or more elements to be masked in the user-generated content;
iii) viewing the user-generated content without any of its elements being masked in the case of the user-generated content being masked;
iv) preventing the user-generated content from being presented to other users;

107. The computer system of claim 106, further comprising:
with a processor-implemented revenue sharing module, sharing the revenue between a plurality of users in the event that the privileged user regarding the user-generated content receives a price in exchange for transferring his privilege regarding the content;

108. The computer system of claim 75, wherein the user-generated content comprises one or more of the group consisting of text, images, audios, and videos;

109. A computer system, comprising:
a processor;
a memory device holding an instruction set executable on the processor to cause the computer system to perform operations comprising:
receiving, from a first user, user-generated content;
determining, with a processor-implemented content masking module, one or more elements to be masked in the user-generated content received from the first user;
receiving, from a second user, a request to present the user-generated content received from the first user;
in response to the request, presenting to the second user the user-generated content wherein the one or more elements to be masked associated with the user-generated content are masked;

110. The computer system of claim 109, further comprising:
receiving, from the first user, user input specifying one or more requests for reward in exchange for disclosing the user-generated content without any of its elements being masked;
presenting, to the second user, the one or more requests for reward associated with the user-generated content;
receiving, from the second user, one or more of the requested rewards that are presented;
determining, with a processor-implemented content unlock module, whether all requests for reward associated with the user-generated content are fulfilled by the second user;
presenting, to the second user, the user-generated content without any of its elements being masked in the case that the second user fulfills all requests for reward associated with the user-generated content;

111. The computer system of claim 109, wherein the user-generated content comprises one or more of the group consisting of text, images, audios, and videos;
